(19) United States
(12) Patent Application Publication
(10) Pub. No.: US 2019/0294690 A1
(43) Pub. Date: Sep. 26, 2019

(54) MEDIA CONTENT ITEM RECOMMENDATION SYSTEM

(71) Applicant: Spotify AB, Stockholm (SE)

(72) Inventors: Rafiel Joshua Yap Pastor, Rego Park, NY (US); Lu Han, New York, NY (US); Mesfin Bekele Mekonnen, New York, NY (US)

(21) Appl. No.: 15/926,737

(22) Filed: Mar. 20, 2018

(51) Int. Cl. G06F 17/30

(52) U.S. Cl. CPC G06F 17/30053; G06F 17/30038; G06F 17/30029

(57) ABSTRACT

A media content item recommendation system operates to assist a user to make a media content playlist. The system provides a set of suggestions that can be used to characterize a playlist, receive a user selection of one or more suggestions from the set of suggestions, and recommend a list of media content items for the playlist based on the user selection.

### BACKGROUND

People enjoy consuming media content, such as listening to audio content or watching video content. Examples of audio content include songs, albums, podcasts, and audiobooks. Examples of video content include movies, music videos, and television episodes. Using a mobile phone or other media-playback device a person can access large catalogs of media content. For example, a user can access an almost limitless catalog of media content through various free and subscription-based streaming services. Additionally, a user can store a large catalog of media content on his or her mobile device.

Playlists are sometimes used to manage and save a list of media content items that users want to consume. However, nearly limitless access to media content introduces several challenges for users who use playlists. For example, it may be difficult to find or select the right media content elements that a user wants to add to a particular playlist. In particular, it is time-consuming to determine media content elements for a playlist from scratch, especially if a user does not have a particular theme for the playlist in mind.

### SUMMARY

In general terms, the present disclosure relates to a media content item recommendation system. In one possible configuration and by non-limiting example, the system operates to assist a user to characterize a playlist and determine media content items for the playlist based on the user's characterization of the playlist. Various aspects are described in this disclosure, which include, but are not limited to, the following aspects.

One aspect is a method for recommending media content items for a playlist. The method includes generating a plurality of playlist character suggestions; receiving a user selection of at least one of the plurality of playlist character suggestions; determining media content items based on the user selection; and associating the determined media content items with the playlist.

In certain examples, the method further includes transmitting data to a media playback device, the data usable to play the media content items via the media playback device. In certain examples, the method further includes updating the plurality of playlist character suggestions with new playlist character suggestions based on the user selection. In certain examples, the method further includes displaying a plurality of control elements associated with the plurality of playlist character suggestions.

In certain examples, each of the plurality of control elements is configured as a tile. In certain examples, each of the plurality of control elements includes a description of a playlist character suggestion.

In certain examples, the description of a playlist character suggestion includes at least one of a media content item name, an artist name, an album name, a playlist identifier, a user identifier, and a string descriptive of a theme, genre, mood, or era.

In certain examples, the plurality of playlist character suggestions is generated based on at least one of a general popularity, a user history, and a user selection of playlist character suggestion.

In certain examples, the media content items are determined using a playlist-based recommendation engine.

In certain examples, the media content items are determined using a vector-based recommendation engine.

Another aspect is a method of playing media content items. The method includes generating a user interface on a media playback device, the user interface associated with a playlist; presenting a plurality of playlist character suggestions in the user interface; receiving a user selection of at least of the plurality of playlist character suggestions; presenting at least one recommended media content item in the user interface, the at least one recommended media content items being determined based on the user selection of at least of the plurality of playlist character suggestions; and enabling a user to play the recommended media content items on the media playback device.

In certain examples, the method includes updating the plurality of playlist character suggestions by replacing the at least of the plurality of playlist character suggestions with new playlist character suggestions.

In certain examples, presenting a plurality of playlist character suggestions includes displaying a plurality of control elements associated with the plurality of playlist character suggestions.

In certain examples, each of the plurality of control elements is configured as a tile.

In certain examples, each of the plurality of control elements includes a description of a playlist character suggestion. In certain examples, the description of a playlist character suggestion includes at least one of a media content item name, an artist name, an album name, a playlist identifier, a user identifier, and a string descriptive of a theme, genre, mood, or era.

In certain examples, the plurality of playlist character suggestions is generated based on at least one of a general popularity, a user history, and a user selection of playlist character suggestion.

In certain examples, the at least one recommended media content item is determined using a playlist-based recommendation engine.

In certain examples, the at least one recommended media content item is determined using a vector-based recommendation engine.

Yet another aspect is a system for delivering media content items using a playlist. The system includes a processing device, a media data store storing a plurality of media content items, and a computer readable data storage medium storing software instructions that, when executed by the processing device, cause the system to receive a request for creating a playlist; receive a request for playlist making assistance; generate a plurality of playlist character suggestions; receive a user selection of one or more of the plurality of playlist character suggestions; determine media content items based on the user selection; associate the determined media content items with the playlist; and enable a user to play back the determined media content items.

Yet another aspect a method for recommending media content items for a playlist. The method may include: receiving a user request for creating a new playlist; generating a plurality of playlist character suggestions, each of the playlist character suggestions usable to characterize the new playlist; receiving a user selection of at least one of the plurality of playlist character suggestions; determining media content items based on the selected playlist character suggestions; and adding the determined media content items to the new playlist.

In certain examples, the method may further include removing the selected playlist character suggestions from the plurality of playlist character suggestions; and replacing the selected playlist character suggestions with new playlist character suggestions.

In certain examples, the method may further include removing at least one unselected playlist character suggestion from the plurality of playlist character suggestions; and replacing the at least one unselected playlist character suggestion with a new playlist character suggestion.

In certain examples, the method may further include displaying a plurality of control elements associated with the plurality of playlist character suggestions. One example of the control elements is in the form of tiles. Each of the plurality of control elements includes a description of a playlist character suggestion, and the description of a playlist character suggestion includes at least one of a media content item name, an artist name, an album name, a playlist identifier, a user identifier, and a string descriptive of a theme, genre, mood, or era.

In certain examples, the plurality of playlist character suggestions is generated based on at least one of a general popularity, a user history, and a user selection of playlist character suggestion.

### BRIEF DESCRIPTION OF THE DRAWINGS

FIG. 1 illustrates an example system for assisting a user to make a media content playlist.

FIG. 2 is a schematic illustration of the system of FIG. 1.

FIG. 3 is a flowchart illustrating an example method for assisting a user to make a media content playlist with recommended media content items.

FIG. 4 illustrates an example playlist character suggestion.

FIG. 5 is a flowchart illustrating an example method for generating the playlist character suggestions.

FIG. 6 schematically illustrates a user interface that presents the playlist character suggestions and receives a user selection thereof.

FIG. 7 is a flowchart illustrating an example method for determining media content items based on the selected playlist character suggestions.

FIG. 8 illustrates an example media content item recommendation engine.

FIG. 9 is a flowchart illustrating an example method for selecting different media content item recommendation engines.

FIG. 10 illustrates an example method for operating a playlist-based recommendation engine.

FIG. 11 illustrates an example method for operating a vector-based recommendation engine.

FIG. 12 illustrates another example method for operating the vector-based recommendation engine.

FIG. 13A illustrates an example user interface presented on a user computing device.

FIG. 13B illustrates the user interface shown in FIG. 13A with different information.

FIG. 13C illustrates the user interface shown in FIG. 13A with different information.

FIG. 13D illustrates the user interface shown in FIG. 13A with different information.

FIG. 13E illustrates the user interface shown in FIG. 13A with different information.

FIG. 14A illustrates another embodiment of the user interface shown in FIG. 13C.

FIG. 14B illustrates another embodiment of the user interface shown in FIG. 13D.

FIG. 15A illustrates another example of the user interface shown in FIG. 13A.

FIG. 15B illustrates the user interface shown in FIG. 15A with different information.

FIG. 15C illustrates the user interface shown in FIG. 15A with different information.

FIG. 15D illustrates the user interface shown in FIG. 15A with different information.

### DETAILED DESCRIPTION

Various embodiments will be described in detail with reference to the drawings, wherein like reference numerals represent like parts and assemblies throughout the several views.

In general, the present disclosure provides a system for assisting a user to make a media content playlist. The system operates to provide a set of suggestions that can characterize a playlist, receive a user selection of one or more suggestions from the set of suggestions, and recommend a list of media content items for the playlist based on the user selection. The suggestions can be presented to the user in the form of selectable control elements, such as tiles, in a user interface. The control elements can include descriptions, such as words or phrases, which are representative of the corresponding suggestions so that the user can select the control elements based on the descriptions. Examples of the descriptions include a media content item name, an artist name, an album name, a playlist identifier, a user identifier, and a string descriptive of a theme, genre, mood, era, or other descriptive words or phrases. As the user selects one or more from the set of suggestions, the set of suggestions can be updated with new suggestions by replacing the selected suggestions with the new suggestions. In addition, one or more of the non-selected suggestions can also be removed and replaced with new suggestions in accordance with the user selection of suggestions. For example, the user selection of suggestions can be evaluated to infer a user's taste and determine if one or more of the non-selected suggestions reflect the user's taste. Once one or more of the non-selected suggestions do not meet the user's taste, they can be replaced with new suggestions.

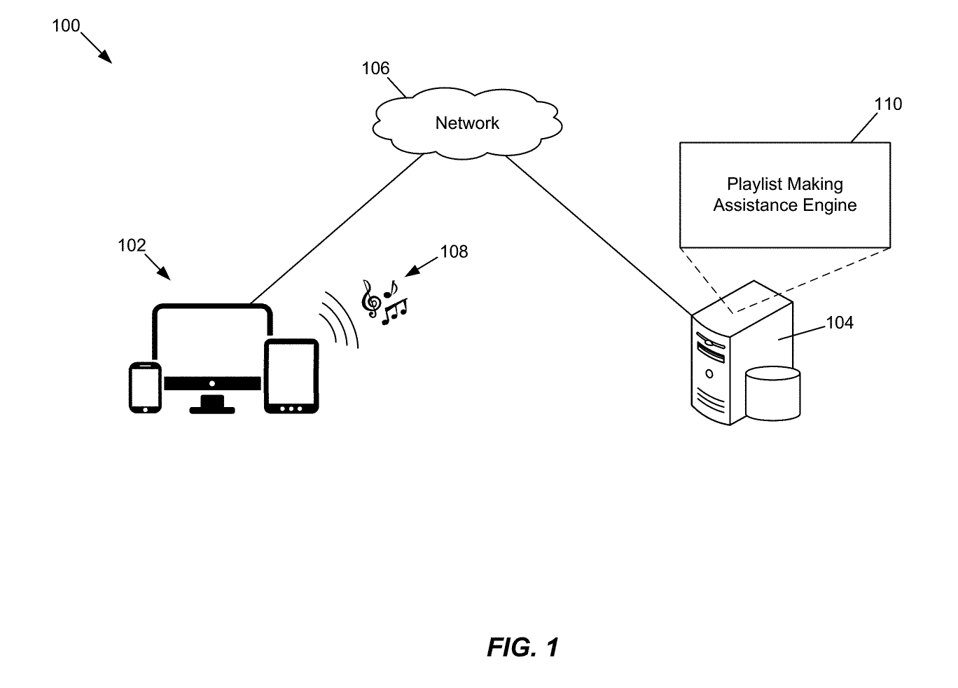

FIG. 1 illustrates an example system 100 for assisting a user to make a media content playlist. In some embodiments, the system 100 operates to recommend one or more media content items that can be added to a media content playlist. The example system 100 includes a media-playback device 102 and a media delivery system 104. The system 100 communicates across a network 106. A playlist making assistance engine 110 runs on the media delivery system 104.

The media-playback device 102 operates to play media content items to produce media output 108 in one or more formats, such as audible, visible, and tactile outputs. In some embodiments, the media content items are provided by the media delivery system 104 and transmitted to the media-playback device 102 using the network 106. A media content item is an item of media content, including audio, video, or other types of media content, which may be stored in any format suitable for storing media content. Non-limiting examples of media content items include songs, albums, music videos, movies, television episodes, podcasts, other types of audio or video content, and portions or combinations thereof.

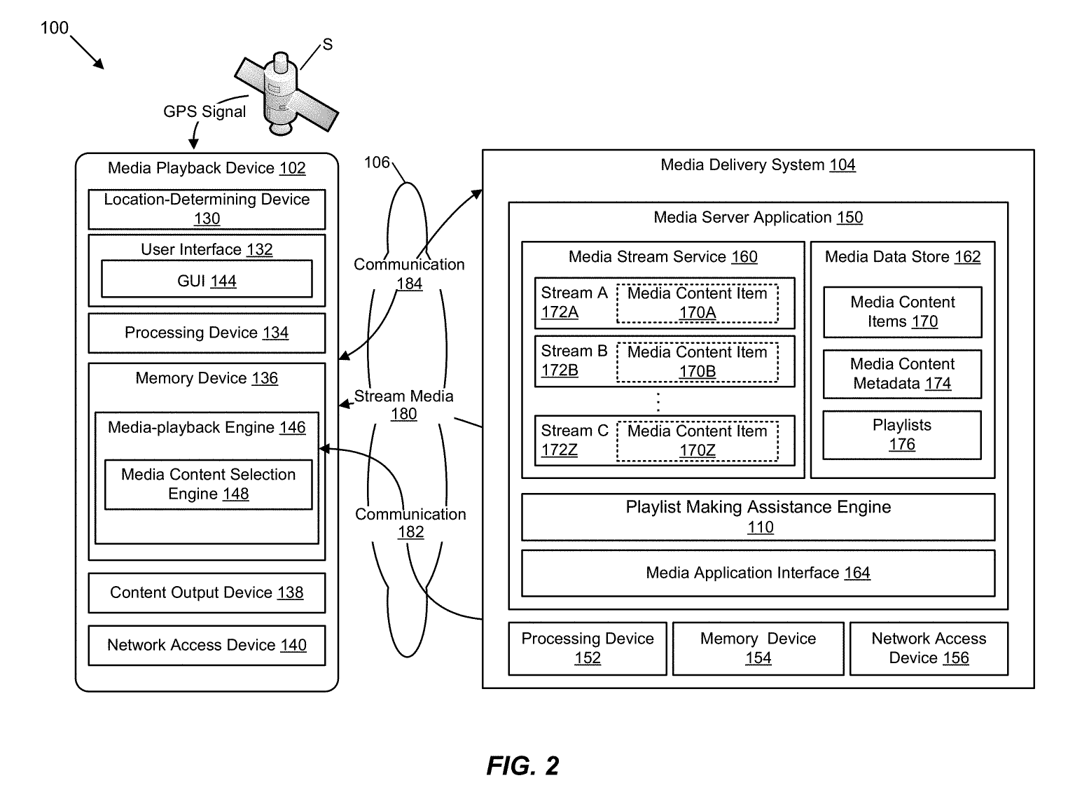

The media delivery system 104 operates to store and manage media content items. The media delivery system 104 also can operate to transmit media content items to the media-playback device 102 via the network 106. Examples of the media-playback device 102, the media delivery system 104, and the network 106 are further described with reference to FIG. 2.

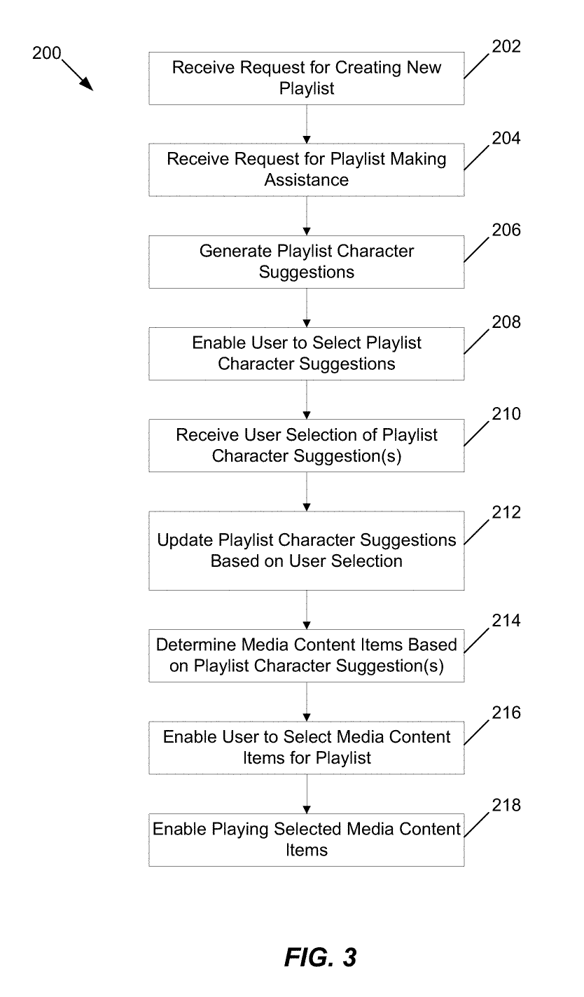

The playlist making assistance engine 110 operates to assist a user to define a theme of the playlist and provide a recommendation of media content items based on the theme of the playlist. In some embodiments, the playlist making assistance engine 110 generates a list of playlist character suggestions and enables a user to select one or more of the suggestions. The playlist making assistance engine 110 operates to generate a list of recommended media content items based on the selection of the suggestions. An example of the playlist making assistance engine 110 is described in more detail with reference to FIG. 3.

FIG. 2 is a schematic illustration of an example system 100 for assisting a user to make a media content playlist. In the illustrated example, the media-playback device 102, the media delivery system 104, and the network 106 are shown.

As noted above, the media-playback device 102 operates to play media content items. In some embodiments, the media-playback device 102 operates to play media content items that are provided (e.g., streamed, transmitted, etc.) by a system external to the media-playback device such as the media delivery system 104, another system, or a peer device. Alternatively, in some embodiments, the media-playback device 102 operates to play media content items stored locally on the media-playback device 102. Further, in at least some embodiments, the media-playback device 102 operates to play media content items that are stored locally as well as media content items provided by other systems.

In some embodiments, the media-playback device 102 is a computing device, handheld entertainment device, smartphone, tablet, watch, wearable device, or any other type of device capable of playing media content. In yet other embodiments, the media-playback device 102 is a laptop computer, desktop computer, television, gaming console, set-top box, network appliance, blue-ray or DVD player, media player, stereo, or radio.

In at least some embodiments, the media playback device 102 includes a location-determining device 130, a user interface 132, a processing device 134, a memory device 136, a content output device 138, and a network access device 140. Other embodiments may include additional, different, or fewer components. For example, some embodiments may include a recording device such as a microphone or camera that operates to record audio or video content. As another example, some embodiments do not include one or more of the location-determining device 130 and the user interface 132.

The location-determining device 130 is a device that determines the location of the media playback device 102. In some embodiments, the location-determining device 130 uses one or more of the following technologies: Global Positioning System (GPS) technology which may receive GPS signals from satellites S, cellular triangulation technology, network-based location identification technology, Wi-Fi positioning systems technology, and combinations thereof.

The user interface 132 operates to receive an input from a user. In some embodiments, the user interface includes a touch sensitive display screen that operates as both a display device and a user input device. In some embodiments, the touch screen detects inputs based on one or both of touches and near-touches. In some embodiments, the user interface 132 includes a graphical user interface 144, which is displayed on a display screen of the media-playback device 102, for interacting with the media-playback device 102. As noted above, some embodiments do not include a touch screen. Some embodiments include a display device and one or more separate user interface devices. Further, some embodiments do not include a display device.

In some embodiments, the processing device 134 comprises one or more central processing units (CPU). In other embodiments, the processing device 134 additionally or alternatively includes one or more digital signal processors, field-programmable gate arrays, or other electronic circuits.

The memory device 136 operates to store data and instructions. In some embodiments, the memory device 136 stores instructions for a media playback engine 146 that includes a media content selection engine 148.

The memory device 136 typically includes at least some form of computer-readable media. Computer readable media include any available media that can be accessed by the media playback device 102. By way of example, computer-readable media include computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory and other memory technology, compact disc read only memory, blue ray discs, digital versatile discs or other optical storage, magnetic cassettes, magnetic tape, magnetic disk storage or other magnetic storage devices, or any other medium that can be used to store the desired information and that can be accessed by the media playback device 102. In some embodiments, computer readable storage media is non-transitory computer readable storage media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The content output device 138 operates to output media content. In some embodiments, the content output device 138 generates media output 108 (FIG. 1) for the user U. Examples of the content output device 138 include a speaker, an audio output jack, a Bluetooth transmitter, a display panel, and a video output jack. Other embodiments are possible as well. For example, the content output device 138 may transmit a signal through the audio output jack or Bluetooth transmitter that can be used to reproduce an audio signal by a connected or paired device such as headphones or a speaker.

The network access device 140 operates to communicate with other computing devices over one or more networks, such as the network 106. Examples of the network access device include wired network interfaces and wireless network interfaces. Wireless network interfaces includes infrared, BLUETOOTH® wireless technology, 802.11a/b/g/n/ac, and cellular or other radio frequency interfaces in at least some possible embodiments.

The media playback engine 146 operates to play back one or more of the media content items (e.g., music) to the user U. As described herein, the media playback engine 146 is configured to communicate with the media delivery system 104 to receive one or more media content items (e.g., through the stream media 180) In other embodiments, the media-playback engine 166 is configured to playback one or more media content items that are locally stored in the media-playback device 102.

The media content selection engine 148 operates to retrieve one or more media content items. In some embodiments, the media content selection engine 148 is configured to send a request to the media delivery system 104 for media content items and receive information about such media content items for playback. In some embodiments, media content items can be stored in the media delivery system 104. In other embodiments, media content items can be stored locally in the media playback device 102. In yet other embodiments, some media content items can be stored locally in the media playback device 102 and other media content items can be stored in the media delivery system 104.

With still reference to FIG. 2, the media delivery system 104 includes one or more computing devices and operates to provide media content items to the media playback devices 102 and, in some embodiments, other media playback devices as well. In some embodiments, the media delivery system 104 operates to transmit stream media 180 to media playback devices such as the media playback device 102.

In at least some embodiments, the media delivery system 104 is provided by multiple computing devices. For example, the media delivery system 104 may be provided by multiple redundant servers located in multiple geographic locations.

In some embodiments, the media delivery system 104 includes a media server application 150, a processing device 152, a memory device 154, and a network access device 156. The processing device 152, memory device 154, and network access device 156 may be similar to the processing device 134, memory device 136, and network access device 140 respectively, which have each been previously described.

In some embodiments, the media server application 150 operates to stream music or other audio, video, or other forms of media content. The media server application 150 includes a media stream service 160, a media data store 162, and a media application interface 164.

The media stream service 160 operates to buffer media content such as media content items 170 (including 170A, 170B, and 170Z) for streaming to one or more streams 172A, 172B, and 172Z.

The media application interface 164 can receive requests or other communication from media playback devices or other systems, to retrieve media content items from the media delivery system 104. For example, in FIG. 2, the media application interface 164 receives communication 182 from the media playback engine 146.

In some embodiments, the media data store 162 stores media content items 170, media content metadata 174, and playlists 176. The media data store 162 may comprise one or more databases and file systems. Other embodiments are possible as well. As noted above, the media content items 170 may be audio, video, or any other type of media content, which may be stored in any format for storing media content.

The media content metadata 174 operates to provide various pieces of information associated with the media content items 170. In some embodiments, the media content metadata 174 includes one or more of title, artist name, album name, length, genre, mood, era, etc.

In some embodiments, the media content metadata 174 includes acoustic metadata, cultural metadata, and explicit metadata. The acoustic metadata may be derived from analysis of the track refers to a numerical or mathematical representation of the sound of a track. Acoustic metadata may include temporal information such as tempo, rhythm, beats, downbeats, tatums, patterns, sections, or other structures. Acoustic metadata may also include spectral information such as melody, pitch, harmony, timbre, chroma, loudness, vocalness, or other possible features. Acoustic metadata may take the form of one or more vectors, matrices, lists, tables, and other data structures. Acoustic metadata may be derived from analysis of the music signal. One form of acoustic metadata, commonly termed an acoustic fingerprint, may uniquely identify a specific track. Other forms of acoustic metadata may be formed by compressing the content of a track while retaining some or all of its musical characteristics.

The cultural metadata refers to text-based information describing listeners' reactions to a track or song, such as styles, genres, moods, themes, similar artists and/or songs, rankings, etc. Cultural metadata may be derived from expert opinion such as music reviews or classification of music into genres. Cultural metadata may be derived from listeners through websites, chatrooms, blogs, surveys, and the like. Cultural metadata may include sales data, shared collections, lists of favorite songs, and any text information that may be used to describe, rank, or interpret music. Cultural metadata may also be generated by a community of listeners and automatically retrieved from Internet sites, chat rooms, blogs, and the like. Cultural metadata may take the form of one or more vectors, matrices, lists, tables, and other data structures. A form of cultural metadata particularly useful for comparing music is a description vector. A description vector is a multi-dimensional vector associated with a track, album, or artist. Each term of the description vector indicates the probability that a corresponding word or phrase would be used to describe the associated track, album or artist.

The explicit metadata refers to factual or explicit information relating to music. Explicit metadata may include album and song titles, artist and composer names, other credits, album cover art, publisher name and product number, and other information. Explicit metadata is generally not derived from the music itself or from the reactions or opinions of listeners.

At least some of the metadata 174, such as explicit metadata (names, credits, product numbers, etc.) and cultural metadata (styles, genres, moods, themes, similar artists and/or songs, rankings, etc.), for a large library of songs or tracks can be evaluated and provided by one or more third party service providers. Acoustic and cultural metadata may take the form of parameters, lists, matrices, vectors, and other data structures. Acoustic and cultural metadata may be stored as XML files, for example, or any other appropriate file type. Explicit metadata may include numerical, text, pictorial, and other information. Explicit metadata may also be stored in an XML, or other file. All or portions of the metadata may be stored in separate files associated with specific tracks. All or portions of the metadata, such as acoustic fingerprints and/or description vectors, may be stored in a searchable data structure, such as a k-D tree or other database format.

The playlists 176 operate to identify one or more of the media content items 170. In some embodiments, the playlists 176 identify a group of the media content items 170 in a particular order. In other embodiments, the playlists 176 merely identify a group of the media content items 170 without specifying a particular order. Some, but not necessarily all, of the media content items 170 included in a particular one of the playlists 176 are associated with a common characteristic such as a common genre, mood, or era.

In some embodiments, the playlist 176 includes a playlist title and a list of content media item identifications. The playlist title is a title of the playlist, which can be provided by a user using the media-playback device 102. The list of content media item identifications includes one or more media content item identifications (IDs) that refer to respective media content items 170.

Each media content item is identified by a media content item ID and includes various pieces of information, such as a media content item title, artist identification (e.g., individual artist name or group name, or multiple artist names or group names), and media content item data. In some embodiments, the media content item title and the artist ID are part of the media content metadata 174, which can further include other attributes of the media content item, such as album name, length, genre, mood, era, etc. as described herein.

Referring still to FIG. 2, the network 106 is an electronic communication network that facilitates communication between the media playback device 102 and the media delivery system 104. An electronic communication network includes a set of computing devices and links between the computing devices. The computing devices in the network use the links to enable communication among the computing devices in the network. The network 106 can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices.

In various embodiments, the network 106 includes various types of links. For example, the network 106 can include wired and/or wireless links, including Bluetooth, ultra-wideband (UWB), 802.11, ZigBee, cellular, and other types of wireless links. Furthermore, in various embodiments, the network 106 is implemented at various scales. For example, the network 106 can be implemented as one or more local area networks (LANs), metropolitan area networks, subnets, wide area networks (such as the Internet), or can be implemented at another scale. Further, in some embodiments, the network 106 includes multiple networks, which may be of the same type or of multiple different types.

Although FIG. 2 illustrates only a single media playback device 102 communicable with a single media delivery system 104, in accordance with some embodiments, the media delivery system 104 can support the simultaneous use of multiple media playback devices, and/or the media playback device can simultaneously access media content from multiple media delivery systems. Additionally, although FIG. 2 illustrates a streaming media based system for the playlist making assistance engine 110, other embodiments are possible as well. For example, in some embodiments, the media playback device 102 includes a media data store 162 and the media playback device 102 is configured to perform some or all of the operations of the playlist making assistance engine 110 without accessing the media delivery system 104. Further in some embodiments, the media playback device 102 operates to store previously streamed media content items in a local media data store.

In at least some embodiments, the media delivery system 104 can be used to stream, progressively download, or otherwise communicate music, other audio, video, or other forms of media content items to the media-playback device 102.

FIG. 3 is a flowchart illustrating an example method 200 for assisting a user to make a media content playlist with recommended media content items. The method 200 can be performed by the playlist making assistance engine 110 with or without other elements of the media playback device 102 and/or the media delivery system 104. As illustrated herein, the playlist making assistance engine 110 is primarily described as being included in the media delivery system 104. Thus, it is primarily described that the method 200 is performed by the media delivery system 104. In other embodiments, however, the method 200 can be performed by the media playback device 102. In yet other embodiments, the method 200 can be performed in one or more other computing devices.

The method 200 can begin at operation 202 in which the media delivery system 104 receives a request for creating a new playlist. In some embodiments, the user can provide a user request for a new playlist through the media playback device 102, and the media playback device 102 then transmits a request to the media delivery system 104. In other embodiments, the request can be directly provided to the media delivery system 104.

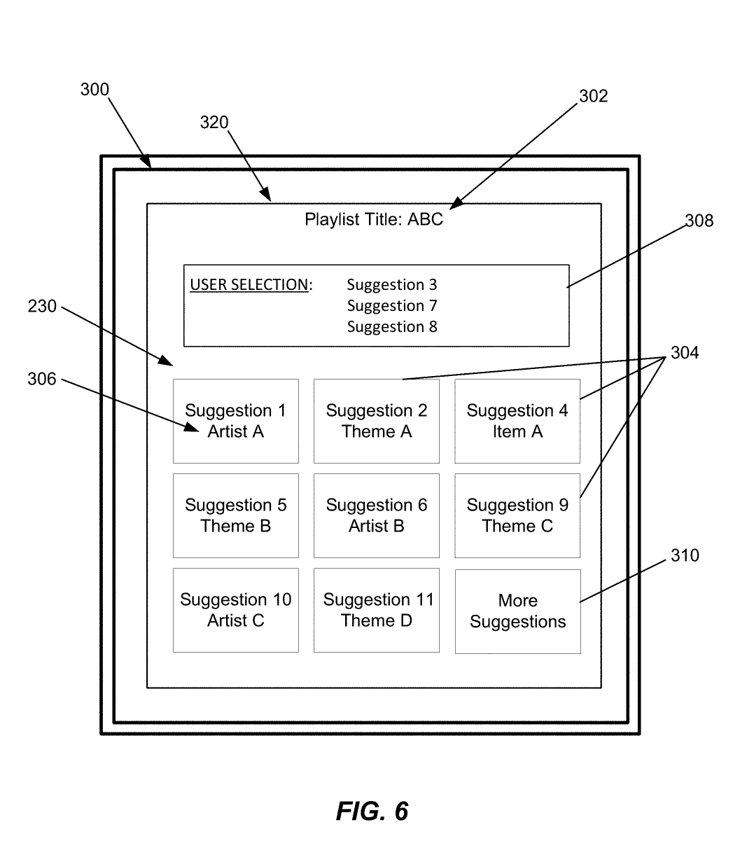

In some embodiments, when creating a playlist, a user can describe the playlist with a playlist title (such as a playlist title 302 in FIG. 6). In other embodiments, a user can assign the playlist other types of description to identify the playlist.

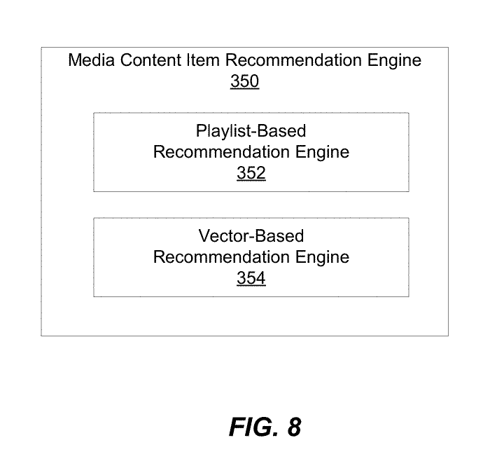

In some embodiments, the playlist title can be used as a basis for generating a list of recommended media content items. For example, the playlist title given by a user can describe the theme (also referred to herein as nature, attribute, or characteristic) of the playlist and thus represent what kind of media content items are included, or intend to be included, in the playlist. In some examples, the playlist with such a descriptive playlist title can be used as a seed playlist which is used to automatically identify a list of recommended media content items for the playlist. An example method for recommending media content items based on the description associated with a playlist, such as a playlist tile, is further described with respect to a playlist-based recommendation engine 352 in FIG. 8. The method for recommending media content items based on a playlist description is also described in U.S. Patent Application Ser. No. 62/441,035, titled MEDIA CONTENT ITEM RECOMMENDATION SYSTEM, filed Dec. 30, 2016, the disclosure of which is incorporated herein by reference in its entirety.

In other embodiments, a playlist can have a non-descriptive title or a generic description, which does not represent or imply the theme of the playlist or media content items included in the playlist. In these cases, it may be difficult to generate media content item recommendations that are helpful or relevant to the playlist. Although recommendations of media content items can be generated, they may not reflect the user's intention or preference of media content items to be included in the playlist. As described below, the playlist making assistance system of the present disclosure allows a user to provide inputs that are descriptive of a playlist other than a playlist title, so that the media content items recommended by the system are relevant and helpful in building the playlist as the user intends.

Although the method 200 is primarily described for a new playlist that is created at the operation 202, the following operations of the method 200 can be identically or similarly applied to an existing playlist.

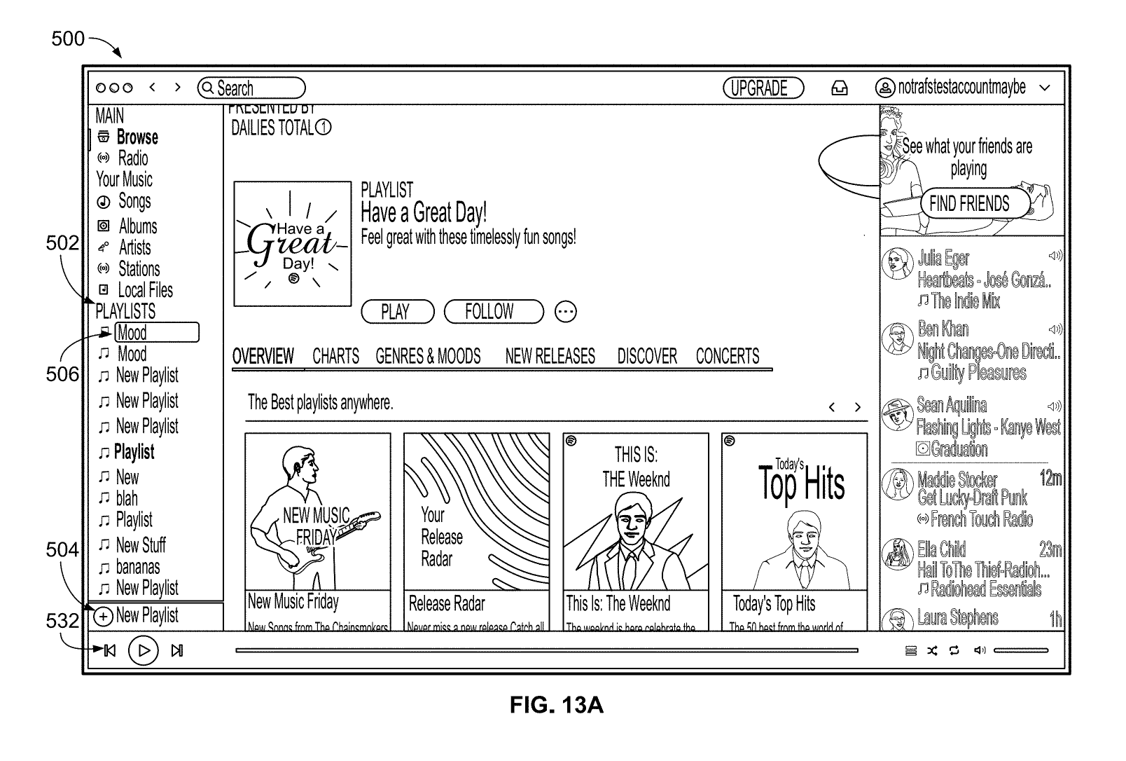

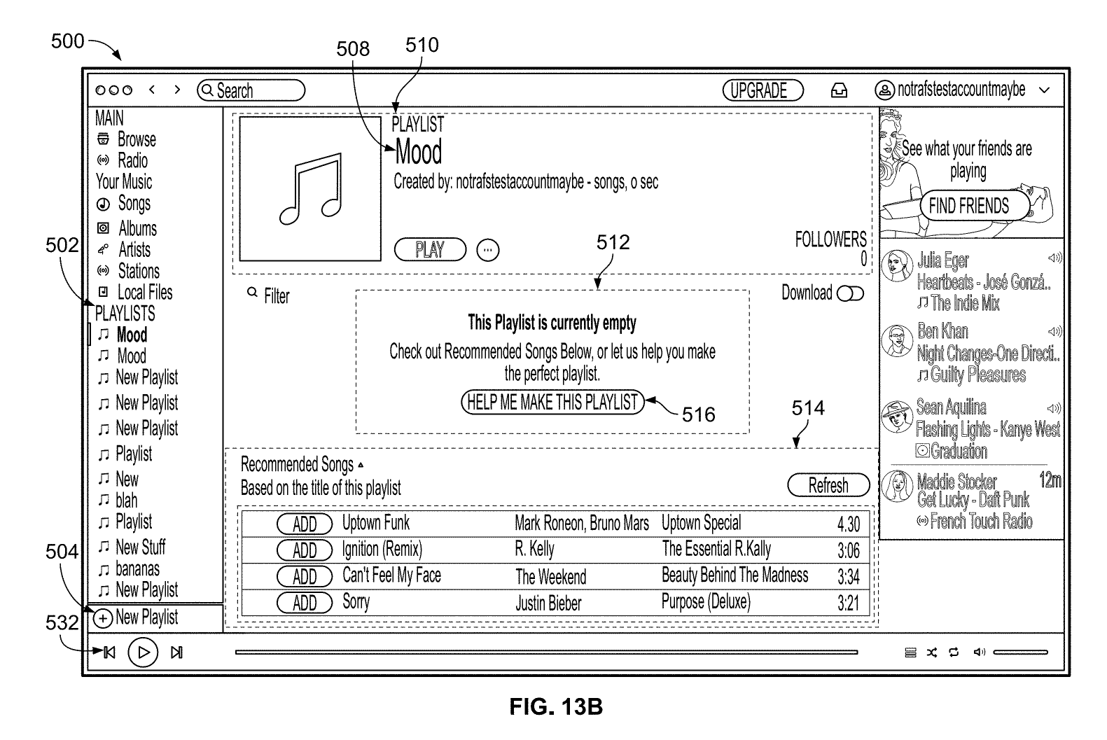

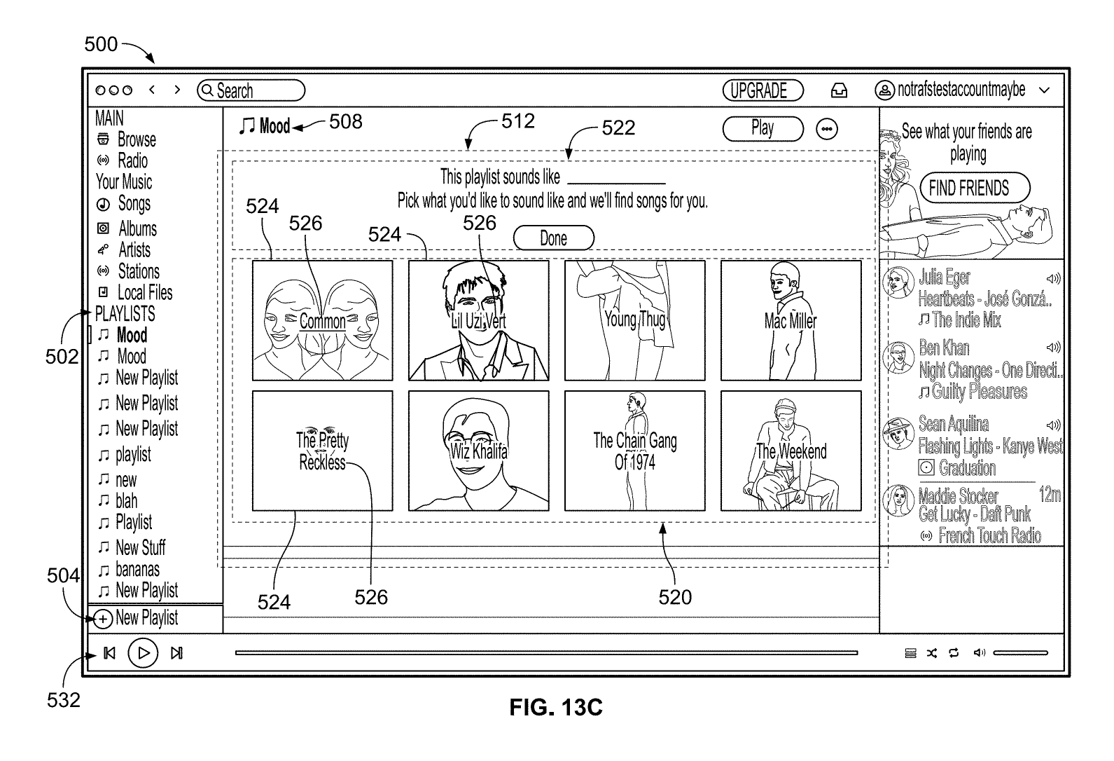

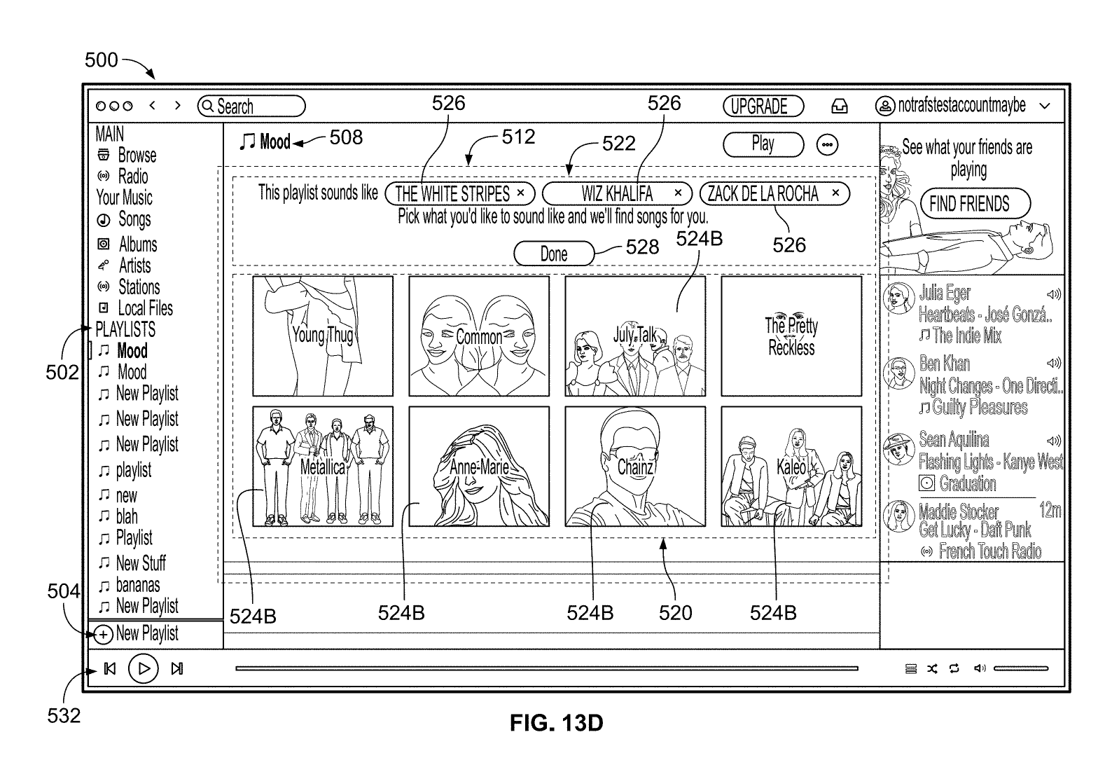

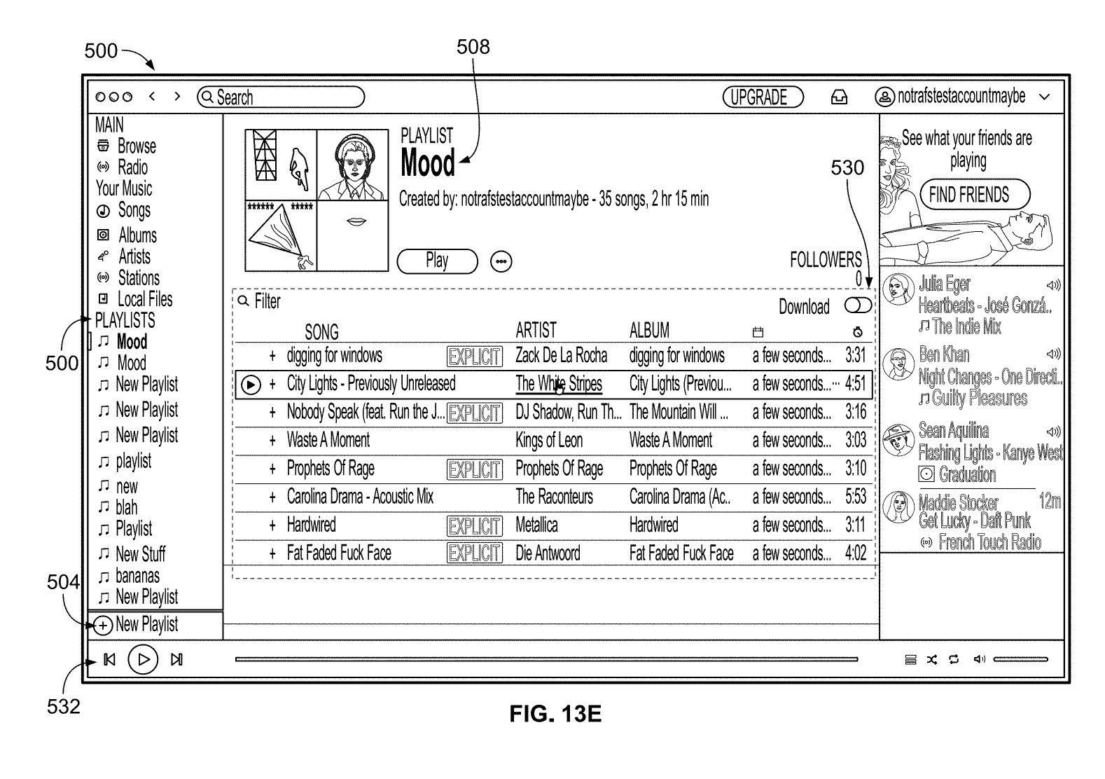

At operation 204, the media delivery system 104 receives a user request for a playlist making assistance. In some embodiments, such a user request can be provided through the media playback device 102. For example, a user interface can be provided to enable the user to enter a request for the playlist making assistance. Examples of the user interface are illustrated in FIGS. 13A-13C, 14A-14B, and 15A-15D.

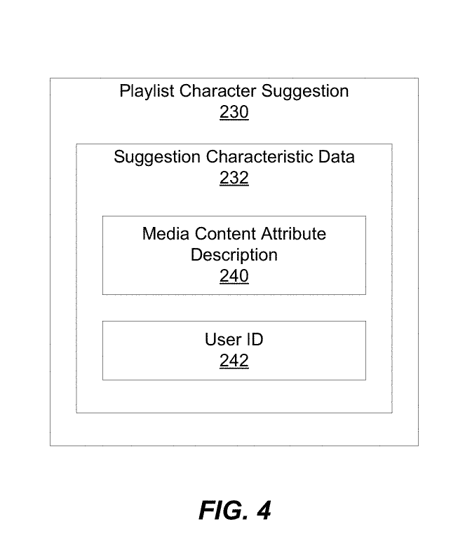

At operation 206, the media delivery system 104 operates to generate one or more playlist character suggestions. The playlist character suggestions include descriptions that can be used to characterize the playlist. Examples of the playlist character suggestions are further described with reference to FIG. 4

At operation 208, the media delivery system 104 enables the user to select one or more of the playlist character suggestions. In some embodiments, the media playback device 102 provides a user interface that presents the playlist character suggestions so that the user can select one or more of the playlist character suggestions through the user interface. An example of the user interface with the playlist character suggestions is illustrated and described with reference to FIG. 6.

At operation 210, the media delivery system 104 operates to receive a user selection of one or more playlist character suggestions. Where the media playback device 102 provides the user interface and receives a user selection of playlist character suggestions, the media playback device 102 can send information about the user selection to the media delivery system 104. In other embodiments, the media playback device 102 operates to directly receive a user selection of playlist character suggestions.

At operation 212, the media delivery system 104 operates to update the playlist character suggestions based on the user selection at the operation 210. As the user selects one or more from a set of playlist character suggestions generated at the operation 206, such user selection may indicate the user's intention (also referred to herein as the user's preference or the user's taste) on the theme of the playlist. Therefore, the user selection of one or more playlist character suggestions can be used to generate new playlist character suggestions which better reflect the theme of the playlist, and the set of playlist character suggestions can be updated with the new playlist character suggestions. In some embodiments, such new playlist character suggestions can replace the previously-selected playlist character suggestions. In other embodiments, one or more playlist character suggestions which have not been selected by the user can be replaced with the new playlist character suggestions. By way of example, if one or more of the non-selected playlist character suggestions are determined to be irrelevant or less relevant to the theme of the playlist (or the user's intention thereon), the set of playlist character suggestions can be updated by replacing those irrelevant or less relevant non-selected playlist character suggestions with the new playlist character suggestions.

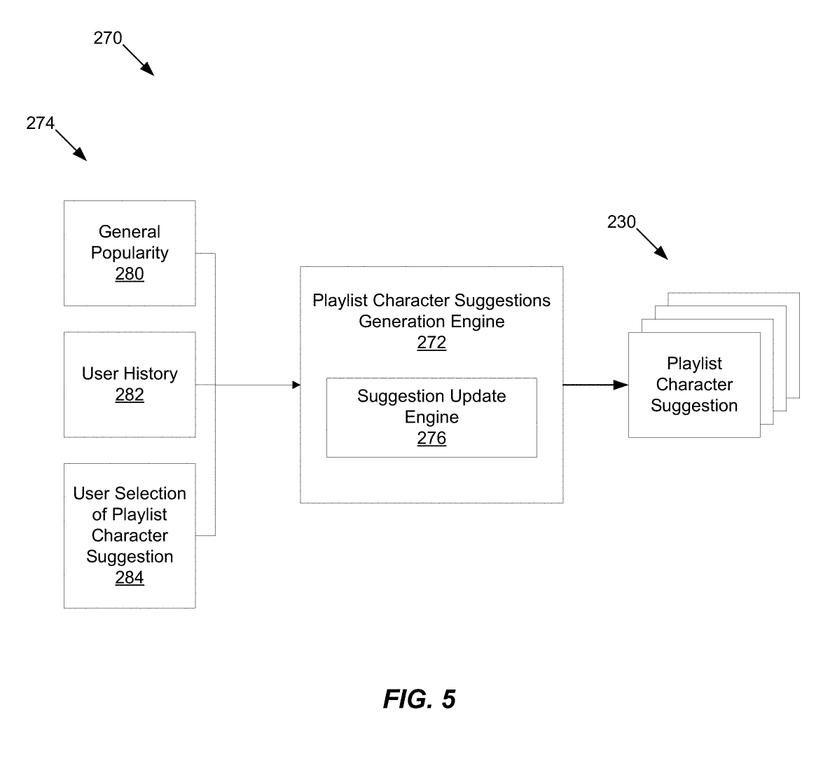

Various methods for generating new playlist character suggestions can be used. An example of such methods is described and illustrated with reference to FIG. 5.

At operation 214, the media delivery system 104 determines media content items for recommendation based on the selected playlist character suggestions. Example methods for generating media content item recommendations are described and illustrated with reference to FIGS. 8-12.

At operation 216, the media delivery system 104 enables the user to select one or more media content items for the playlist from the recommended media content items. In some embodiments, the media playback device 102 provides a user interface that presents the recommendations of media content items and allows the user to select one or more of the media content items to be added to the playlist. An example of the user interface with the playlist character suggestions is illustrated and described with reference to FIG. 13E.

At operation 218, the media delivery system 104 enables playing the media content items associated with the playlist. In some embodiments, the media delivery system 104 transmits data to the media playback device 102, and the media playback device 102 can use the data to play the media content items via the media playback device 102. In some embodiments, such data include the playlist metadata, which can be used to stream the media content items associated with the playlist.

FIG. 4 illustrates an example playlist character suggestion 230. As described above, one or more playlist character suggestions 230 are generated to characterize the playlist. The playlist character suggestions 230 include descriptions which can be used to define the theme of the playlist. The media delivery system 104 can use such descriptions to recommend media content items for the playlist.

The playlist character suggestion 230 includes, or is associated with, suggestion characteristic data 232. The suggestion characteristic data 232 include information that can be used to define the theme (also referred to herein as nature, attribute, or characteristic) of the playlist and determine media content items that are relevant to the theme of the playlist.

When the playlist character suggestions 230 are provided to a user for selection, the suggestion characteristic data 232 of the playlist character suggestions 230 can be presented with one or more words or phrases. As described herein, such words or phrases can describe various information, such as a media content item name, an artist name, an album name, a playlist identifier (ID), a user identifier (ID) and a string indicative of descriptive or non-descriptive information (e.g., a string that describes a theme, genre, mood, era, etc.). In some embodiments, the suggestion characteristic data 232 include a media content attribute description 240 and a user identifier 242.

The media content attribute description 240 includes a description that can be used to identify media content items to be associated with the playlist. In some embodiments, the media content attribute description 240 can include item description information and acoustic attribute information. The item description information includes information that identifies one or more media content item or one or more playlists. For example, the item description information can be at least one of a title, an artist name, an album name, a length, a genre, a theme, a mood, an era, and other information identifying a media content item or a playlist. The acoustic attribute information includes information about acoustic attributes of one or more media content items or one or more playlists. For example, the acoustic attribute information can be at least one of tempo, rhythm, beats, downbeats, tatums, patterns, sections, melody, pitch, harmony, timbre, chroma, loudness, vocalness, and other acoustic attributes.

The user identifier 242 includes information that identifies one or more users of the media content service from the media delivery system 104. In some embodiments, the users identifiable by the user identifiers 242 can be those that relate to the user of the current playlist. For example, the users that can be identified by the user identifiers 242 are those that are associated with the current user, such as users added as friends or contacts of the current user, or users followed by or following the current user). In this document, such other users that are identified by the user identifiers 242 are also referred to as friend users.

In some embodiments, the user identifier 242 is in the form of a Uniform Resource Identifier (URI). Other forms are also possible for the user identifier 242.

FIG. 5 is a flowchart illustrating an example method 270 for generating the playlist character suggestions 230. In some embodiments, the method 270 is used to perform the operation 206 in FIG. 3.

In some embodiments, a playlist character suggestions generation engine 272 is provided to generate one or more playlist character suggestions 230. The playlist character suggestions generation engine 272 operates to use one or more factors 274 to generate the playlist character suggestions 230. Examples of such factors 274 include a general popularity 280, a user history 282, and a user selection of playlist character suggestion 284.

The general popularity 280 indicates the popularity of one or more aspects associated with media content items among multiple users, such as the popularity of media content items, artists, genres, themes, moods, or other possible aspects. In some embodiments, such multiple users include all or some users that can use or access the media content provision service from the media delivery system 104. In other embodiments, the multiple users include users that receive media content services from other servers or service providers. In yet other embodiments, the multiple users include a particular group of users (e.g., friend users) that relate to the user that is currently using the playlist. The multiple users may or may not include the user that is currently using the playlist.

For example, the playlist character suggestions generation engine 272 operates to identify a predetermined number of most popular artists and/or media content items, and use the names of the artists and/or the titles of the media content items as the descriptions of the playlist character suggestions 230. In addition or alternatively, the playlist character suggestions generation engine 272 can use the attributes of the most popular artists and/or media content items to generate the descriptions of the playlist character suggestions 230. By way of example, when the most popular artists and/or media content items are identified, the genre, theme, mood, and/or era of the identified artists and/or media content items are used as the descriptions of the playlist character suggestions 230.

In addition, the general popularity 280 can include the popularity of users other than the user that is currently using the playlist. For example, the playlist character suggestions generation engine 272 can refer to one or more of popular users of the media content provision service from the media delivery system 104, and use their user identifiers or the attributes of the playlists or media content items associated with such users to generate the descriptions of the playlist character suggestions 230.

The user history 282 indicates the history that the user has played, selected, searched, or performed any other actions associated with media content items. In some embodiments, the playlist character suggestions generation engine 272 operates to identify a predetermined number of artists and/or media content items that the user has most recently played, and use the names of the artists and/or the titles of those media content items as the descriptions of the playlist character suggestions 230. In other embodiments, the playlist character suggestions generation engine 272 operates to identify the artists and/or media content items that the user has played most often for a particular period of time, and use the names of the artists and/or the titles of the media content items as the descriptions of the playlist character suggestions 230. In yet other embodiments, the playlist character suggestions generation engine 272 can use the attributes of the identified artists and/or media content items to generate the descriptions of the playlist character suggestions 230. By way of example, the genre, theme, mood, and/or era of the identified artists and/or media content items are used as the descriptions of the playlist character suggestions 230.

In addition, the user history 282 can include other users that relate to the user of the current playlist. For example, the playlist character suggestions generation engine 272 can refer to other users that are associated with the current user (e.g., added as friends or contacts of the current user, or followed by or following the current user), and use their user identifiers or the attributes of the playlists or media content items associated with such friend users to generate the descriptions of the playlist character suggestions 230.

The user selection of playlist character suggestion 284 indicates one or more playlist character suggestions 230 that the user has previously selected. In some embodiments, the user selection of playlist character suggestion 284 is used to update the set of playlist character suggestions 230 while the user is selecting one or more from the set of playlist character suggestions 230, as described with respect to the operation 212 in FIG. 3. As described herein, the previous user selection can imply the user's intention on the theme of the playlist, and thus can be used to generate new playlist character suggestions which better reflect the theme of the playlist. The new playlist character suggestions can be used to update the set of playlist character suggestions 230.

In some embodiments, the playlist character suggestions generation engine 272 generates the playlist character suggestion 230 based on one of the general popularity 280, the user history 282, and the user selection of playlist character suggestion 284. In other embodiments, the playlist character suggestions generation engine 272 generates the playlist character suggestion 230 based on any combination of the general popularity 280, the user history 282, the user selection of playlist character suggestion 284, and any other factors. In yet other embodiments, the playlist character suggestions generation engine 272 operates to randomly generate the playlist character suggestions 230.

Referring still to FIG. 5, some embodiments of the playlist character suggestions generation engine 272 include a suggestion update engine 276. In some embodiments, the suggestion update engine 276 operates to implement the operation 212 in FIG. 3. The suggestion update engine 276 operates to update a set of playlist character suggestions 230 as the user selects one or more playlist character suggestions from the set of playlist character suggestions.

In some embodiments, the playlist character suggestions generation engine 272 is configured to continuously provide the user with a predetermined number of playlist character suggestions 230 as a set. In these embodiments, when the user selects one or more playlist character suggestions from the set of playlist character suggestions, the selected playlist character suggestions need to be replaced with new playlist character suggestions. By way of example, when a set of eight playlist character suggestions are presented to the user and the user selects two playlist character suggestions from the set, two new playlist character suggestions should be added to the set to replace the two selected playlist character suggestions.

In some embodiments, as one of the playlist character suggestions is selected, the suggestion update engine 276 operates to automatically introduce a new playlist character suggestion to replace the selected playlist character suggestion. In other embodiments, the suggestion update engine 276 operates to wait until the user finishes selecting one or more playlist character suggestions, and then introduce one or more new playlist character suggestions together after the user selection is completed.

In other embodiments, the suggestion update engine 276 further operates to replace one or more of the playlist character suggestions 230 that have not been selected, as the user selects one or more from the set of playlist character suggestions 230. The suggestion update engine 276 can operate to determine if any of the existing playlist character suggestions is irrelevant or less relevant to the playlist based on the user's previous selection of the playlist character suggestions from the original set. If one or more of the non-selected playlist character suggestions are determined to be irrelevant or less relevant, such one or more of the non-selected playlist character suggestions can be replaced with a corresponding number of other playlist character suggestions that are generated and determined to be more relevant to the playlist based on the user's previous selection of the playlist character suggestions.

Various methods can be used as the suggestion update engine 276. Some embodiments of the suggestion update engine 276 are configured similarly to a vector-based recommendation engine 354 as further described in FIG. 8.

FIG. 6 schematically illustrates a user interface 300 that presents the playlist character suggestions 230 and receives a user selection thereof. The user interface 300 can be used to perform the operations 208 and 210 in FIG. 3. In some embodiments, the user interface 300 is provided to a user through the media playback device 102. Other computer devices can be used to provide the user interface 300 in other embodiments.

As illustrated, the user interface 300 shows a current playlist 320 with a playlist title 302 (“ABC” in FIG. 6). The user interface 300 further includes a predetermined number of playlist character suggestions 230 that are selectable. In the illustrated example, the user interface 300 is configured to display eight playlist character suggestions 230. However, other numbers of playlist character suggestions 230 can be shown in the user interface 300.

The playlist character suggestions 230 can be displayed in various configurations. For example, various types of control elements can be used to display the playlist character suggestions 230 in the user interface. In the illustrated example, the playlist character suggestions 230 are presented in the form of tiles 304 that include descriptions 306 of the playlist character suggestions 230. The tiles 304 are selectable by a user, and a user selection of one or more playlist character suggestions can be displayed in a user selection display section 308. The descriptions 306 of the tiles 304 can be one or more words or phrases that describe the suggestion characteristic data 232 of the playlist character suggestions 230, as described in FIG. 4. As described herein, examples of such words or phrases include artist names (“Artist A,” “Artist B,” and “Artist C” in FIG. 6), media content item names (“Item A” in FIG. 6), strings (“Theme A,” “Theme B,” “Theme C,” and “Theme D” in FIG. 6), album names, playlist identifiers (IDs), and any other descriptive or non-descriptive strings.

In some embodiments, the user interface 300 provides a control element 310 that is selectable to present additional playlist character suggestions 230. The user can select the control element 310 to find other playlist character suggestions 230 that are generated by the media delivery system 104. In some embodiments, when the control element 310 is selected, the existing playlist character suggestions 230 can be partially or entirely refreshed.

In some embodiments, such other playlist character suggestions 230 (as presented in the form of tiles 304) can replace some or all of the existing playlist character suggestions 230. In other embodiments, such other playlist character suggestions 230 (as presented in the form of tiles 304) can be shown in addition to the existing playlist character suggestions 230.

In some embodiments, the control elements, such as tiles 304, are associated with a Uniform Resource Identifiers (URIs) which identify the suggestion characteristic data 232 (e.g., the descriptions 306) of the playlist character suggestions 230 corresponding to the control elements.

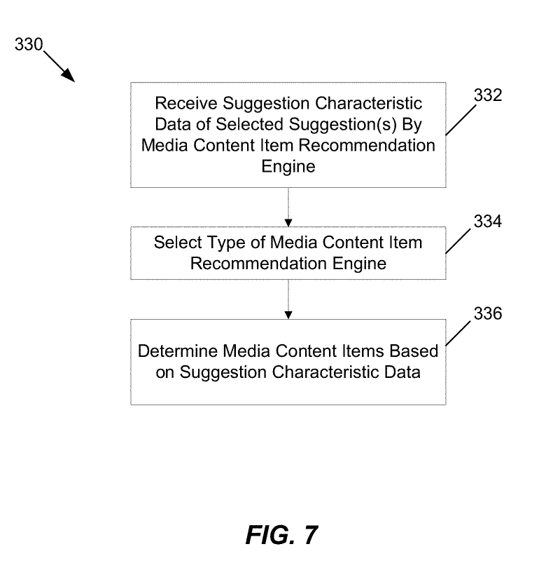

FIG. 7 is a flowchart illustrating an example method 330 for determining media content items based on the selected playlist character suggestions 230. The method 330 can be used to perform the operation 214 in FIG. 3. In some embodiments, a media content item recommendation engine 350, as illustrated in FIG. 8, is used to perform the method 330. The media content item recommendation engine 350 can be part of the playlist making assistance engine 110. As illustrated herein, the playlist making assistance engine 110 is primarily described as being included in the media delivery system 104. Thus, it is primarily described that the method 330 is performed by the media delivery system 104. In other embodiments, however, the method 330 can be performed by the media playback device 102. In yet other embodiments, the method 330 can be performed in one or more other computing devices.

The method 330 begins at operation 332 in which the media delivery system 104 receives the suggestion characteristic data 232 of the selected playlist character suggestions 230. The selection process of playlist character suggestions 230 are described above with reference to FIGS. 4-6.

In some embodiments, the media content item recommendation engine 350 can include a plurality of media content item recommendation engines of different types, as exemplified in FIG. 8. Where a plurality of media content item recommendation engines 350 are available, the media delivery system 104 operates to select a suitable type of media content item recommendation engine 350, at operation 334.

At operation 336, the media delivery system 104 operates to determine one or more media content items based on the suggestion characteristic data 232. For example, the media content item recommendation engine 350 that is selected at the operation 334 uses the suggestion characteristic data 232 and identifies a set of media content items that are suitable for building the playlist that is currently open by the user.

FIG. 8 illustrates an example of the media content item recommendation engine 350. In this example, the media content item recommendation engine 350 includes a playlist-based recommendation engine 352 and a vector-based recommendation engine 354.

As described herein, in some embodiments, the media content item recommendation engine 350 operates to determine one or more media content items from the media content items 170 stored in the media data store 162 (FIG. 2), based on the suggestion characteristic data 232 of the playlist character suggestions 230 that have been selected by the user. As described in FIG. 4, the suggestion characteristic data 232 can include various information, such as factual or explicit information relating to media content items (e.g., media content item titles, album titles, artist names, composer names, other credits, album cover art, publisher name and product number, etc.), a playlist identifier (ID), a user identifier (ID) and a string indicative of descriptive or non-descriptive information. In some embodiments, the string can represent acoustic attributes (as identified in acoustic metadata, such as tempo, rhythm, beats, downbeats, tatums, patterns, sections, melody, pitch, harmony, timbre, chroma, loudness, vocalness, etc.) and/or cultural attributes (as identified in cultural metadata, such as styles, genres, moods, themes, similar artists and/or songs, rankings, etc.).

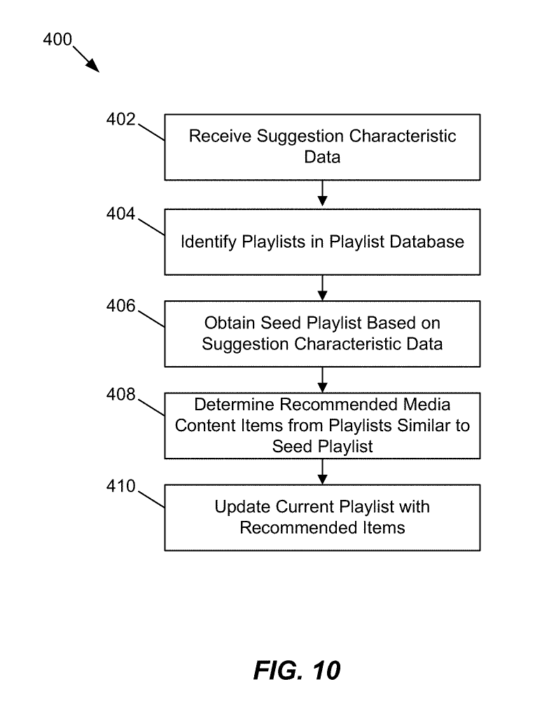

The playlist-based recommendation engine 352 operates to determine media content items from the media content items 170 stored in the media data store 162, using the current playlist with the received suggestion characteristic data 232 as a seed playlist. An example of the playlist-based recommendation engine 352 is further described with reference to FIG. 10.

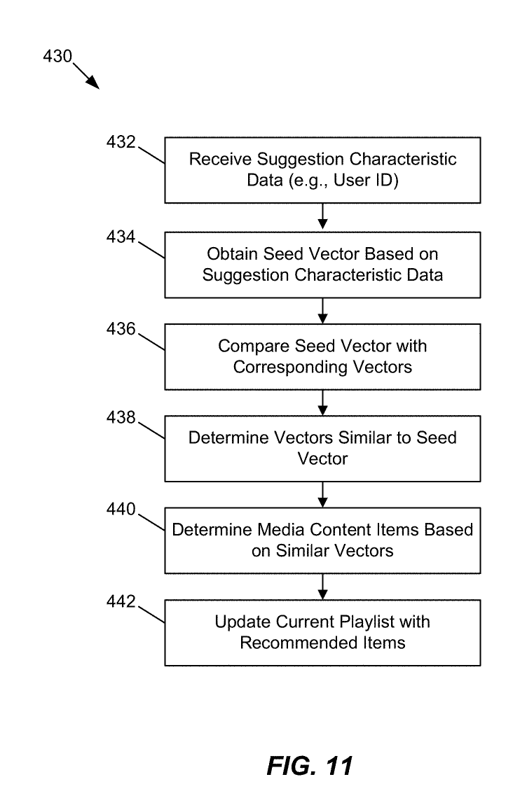

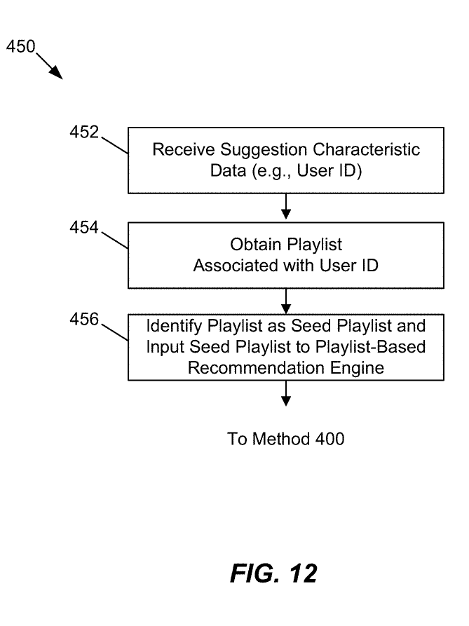

The vector-based recommendation engine 354 operates to determine media content items from the media content items 170 stored in the media data store 162, using the received suggestion characteristic data 232 as a seed vector. Examples of the vector-based recommendation engine 354 are further described with reference to FIGS. 11 and 12.

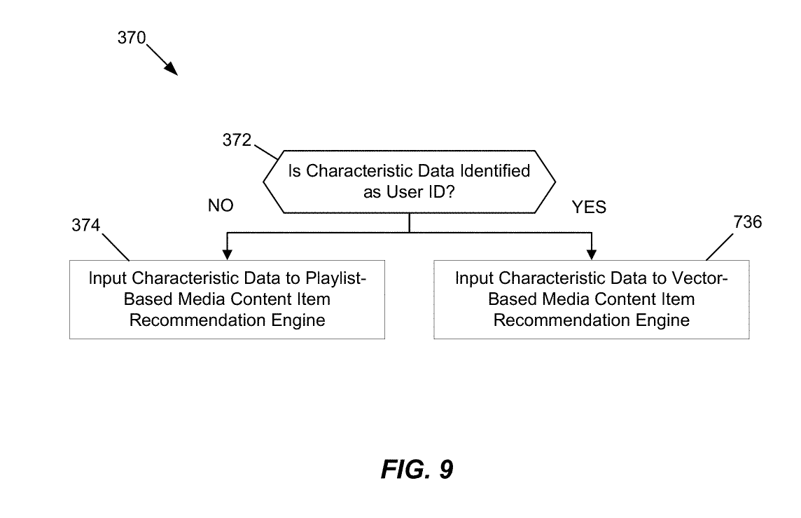

FIG. 9 is a flowchart illustrating an example method 370 for selecting different types of the media content item recommendation engine 350. In this example, the selection method 370 is performed for selecting either the playlist-based recommendation engine 352 or the vector-based recommendation engine 354. The method 370 is primarily described to be performed by the media delivery system 104. In other embodiments, however, the method 370 can be performed by the media playback device 102 or one or more other computing devices.

In this example, the method 370 begins at operation 372 in which the media delivery system 104 determines whether the suggestion characteristic data 232 is identified as, or includes, a user identifier 242 (FIG. 4). If the suggestion characteristic data 232 is identified as, or includes, a user identifier 242 (“YES” at this operation), the method 370 moves on to operation 376. Otherwise (“NO” at this operation), the method 370 continues at operation 374.

At operation 374, the suggestion characteristic data 232, when not identified as a user identifier 242, is inputted to the playlist-based recommendation engine 352. The playlist-based recommendation engine 352 operates to generate one or more playlist character suggestions 230 based on the received suggestion characteristic data 232. An example of the playlist-based recommendation engine 352 is further described with reference to FIG. 10.

At operation 376, the suggestion characteristic data 232 that is identified as a user identifier 242 is inputted to the vector-based recommendation engine 354. Where the suggestion characteristic data 232 includes a user identifier 242 and other types of data (i.e., where a portion of the suggestion characteristic data 232 is identified as a user identifier 242), the user identifier 242 of the suggestion characteristic data 232 can be only inputted to the vector-based recommendation engine 354. In other embodiments, all the suggestion characteristic data 232 including the user identifier 242 and other types of data are inputted into the vector-based recommendation engine 354. The vector-based recommendation engine 354 operates to generate one or more playlist character suggestions 230 based on the received suggestion characteristic data 232. Examples of the vector-based recommendation engine 354 are further described with reference to FIGS. 11 and 12.

The method 370 in FIG. 9 is one example method for selecting different types of the media content item recommendation engine 350. In other embodiments, other methods are possible. For example, regardless of types of data contained in the suggestion characteristic data 232, all the suggestion characteristic data 232 can be used with either the playlist-based recommendation engine 352 or the vector-based recommendation engine 354. In other examples, some of the suggestion characteristic data 232 can be inputted to the playlist-based recommendation engine 352 while the other of the suggestion characteristic data 232 is used with the vector-based recommendation engine 354.

FIG. 10 illustrates an example method 400 for operating the playlist-based recommendation engine 352. The method 400 is primarily described to be performed by the media delivery system 104. In other embodiments, however, the method 400 can be performed by the media playback device 102 or one or more other computing devices.

At operation 402, the playlist-based recommendation engine 352 receives the suggestion characteristic data 232 of the playlist character suggestions 230 that have been selected by the user. In some embodiments, the playlist-based recommendation engine 352 utilizes all kinds of the suggestion characteristic data 232 except for a user identifier or a playlist identifier. For example, various types of data, such as factual data relating to media content items (e.g., media content item titles, album titles, artist names, composer names, other credits, album cover art, publisher name and product number, etc.), acoustic data (e.g., tempo, rhythm, beats, downbeats, tatums, patterns, sections, melody, pitch, harmony, timbre, chroma, loudness, vocalness, etc.), and cultural attributes (e.g., styles, genres, moods, themes, similar artists and/or songs, rankings, etc.). In other embodiments, the playlist-based recommendation engine 352 can also use a user identifier or a playlist identifier to generate recommendation of media content items.

At operation 404, the playlist-based recommendation engine 352 identifies at least some of the playlists 176 stored in the media data store 162 (FIG. 2). The playlists 176 stored in the media data store 162 include playlists which have been created by one or more users over a period of time. The playlist database can be continuously or periodically updated with other playlists which are created by such users. In other embodiments, the playlists 176 can include playlists pre-generated by media content item service providers, such as media streaming service providers.

At operation 406, the playlist-based recommendation engine 352 generates a seed playlist based on the suggestion characteristic data 232. In some embodiments, the seed playlist is generated by associating the suggestion characteristic data 232 with the playlist that is currently open by the user. The suggestion characteristic data 232 assigned to the current playlist is used as a basis to provide recommendation of media content items.

Alternatively, the seed playlist is not generated, and the suggestion characteristic data 232 is directly used as a basis for determining recommendation of media content items.

At operation 408, the playlist-based recommendation engine 352 operates to select at least some of the playlists 176 that are similar to the seed playlist, and determine recommended media content items from the selected playlists. Various methods can be used to determine similarity between the seed playlist and the stored playlists 176. Examples of such methods are described in U.S. Patent Application Ser. No. 62/441,035, titled MEDIA CONTENT ITEM RECOMMENDATION SYSTEM, filed Dec. 30, 2016, the disclosure of which is incorporated herein by reference in its entirety.

At operation 410, the playlist-based recommendation engine 352 can update the current playlist (e.g., the playlist 320 in FIG. 6) with at least one of the recommended media content items. In some embodiments, the playlist-based recommendation engine 352 provides a user interface, such as the user interface 132 of the media-playback device 102 that enables a user to manually add at least one of the recommended media content items to the current playlist. For example, a predetermined number of recommended media content items are presented to the user through the user interface and the user can select one or more of the recommended media content items in the playlist. In other embodiments, the playlist-based recommendation engine 352 can automatically update the current playlist with at least one of the recommended media content items.

FIG. 11 illustrates an example method 430 for operating the vector-based recommendation engine 354. The method 430 is primarily described to be performed by the media delivery system 104. In other embodiments, however, the method 430 can be performed by the media playback device 102 or one or more other computing devices.

In general, the vector-based recommendation engine 354 operates to find media content, such as media content items (e.g., tracks), artists, albums, or playlists, which satisfies a user based on the user's taste. The vector-based recommendation engine 354 can use a user identifier or other media content related information (e.g., track, artist, album, etc.) and obtains a taste vector associated with the user identifier or other media content related information. The taste vector is a vector that reflects the user's taste. The taste vector can have various versions for different contexts. In one example, the taste vector can define the user's long term taste. The long term taste vector can take into account a relatively large number of media content items that the user has played (e.g., the last 2000 tracks the user has streamed). In another example, the taste vector can define the user's real-time listening taste. The real-time listening vector can take into account a relatively small number of media content items that the user has played (e.g., the last 10 tracks the user has streamed). Another example taste vector includes a user's onboarding vector which is constructed from user signals obtained while onboarding the user. Yet another example of the taste vector includes a combination of a long term taste vector and a real-time listening vector.

An example of the vector-based recommendation engine 354 can be implemented with an API tool, such as Vectors™ available from Spotify (Stockholm, Sweden). Vectors™ is a tool powered by several machine learning datasets. In some embodiments, this tool can be used to find nearest media content items for a given user. For example, the tool can use a predetermined number (e.g., two thousand) of the media content items that the user has previously used based on the user's listening history. In addition or alternatively, the tool can use the user's real-time listening history, in which a small number (e.g., twenty) of the media content items that have been played recently (e.g., the last four hours) are found. In addition or alternatively, the tool can look at the information obtained from the questions asked to the user during the user's onboarding process.

In other embodiments, the tool can be used to find the nearest artists for the user. The nearest artists can be found similarly to the nearest media content items as described above. In yet other embodiments, the tool can be used to find the nearest albums for the use. The nearest albums can be found similarly to the nearest media content items as described above. In yet other embodiments, the tool can be used to find the nearest playlists for the users. The nearest playlists can be found similarly to the nearest media content items as described above. Other functions are also provided in the tool.

Referring still to FIG. 11, the method 430 can begin at operation 432 in which the vector-based recommendation engine 354 receives the suggestion characteristic data 232 of the playlist character suggestions 230 that have been selected by the user. In some embodiments, the vector-based recommendation engine 354 can utilize data of a user identifier or a playlist identifier to generate recommendation of media content items. In other embodiments, the vector-based recommendation engine 354 can use other types of the suggestion characteristic data 232, such as factual data relating to media content items (e.g., media content item titles, album titles, artist names, composer names, other credits, album cover art, publisher name and product number, etc.), acoustic data (e.g., tempo, rhythm, beats, downbeats, tatums, patterns, sections, melody, pitch, harmony, timbre, chroma, loudness, vocalness, etc.), and cultural attributes (e.g., styles, genres, moods, themes, similar artists and/or songs, rankings, etc.).

At operation 434, the vector-based recommendation engine 354 obtains a seed vector associated with the suggestion characteristic data 232. The seed vector includes a set of values (in some examples, the set can only have a single value) that is assigned to one or more data elements of the suggestion characteristic data 232. The set of values can represent the one or more data elements of the suggestion characteristic data 232. By way of example, the seed vector includes a set of values assigned to a media content item (e.g., track), representing the media content item. Other types of data elements in the suggestion characteristic data 232, such as an artist, an album, a playlist, etc., can be represented by a seed vector.

Where the suggestion characteristic data 232 includes a user identifier or a playlist identifier, the seed vector can be a taste vector that represents the taste or preference of a user identified by the user identifier or the playlist identifier.

At operation 436, the vector-based recommendation engine 354 operates to compare the seed vector with other corresponding vectors. In some embodiments, such corresponding vectors include vectors that represent the same type of data elements of the suggestion characteristic data 232. By way of example, the seed vector for a media content item is compared with vectors for other media content items. In other embodiments, the corresponding vectors include vectors that represent different types of data elements of the suggestion characteristic data 232. By way of example, the seed vector for a media content item can be compared with vectors for other data elements of the suggestion characteristic data 232, such as artists, albums, playlists, etc.

At operation 438, the vector-based recommendation engine 354 determines vectors that are similar to the seed vector. A similarity between the vectors can be calculated in various ways. In some embodiments, a similarity between two vectors can be determined by calculating the Euclidean distance between the vectors. In other embodiments, any other similarity or comparison measurement can be used to compare two vectors.

In some embodiments, the similarity can be defined in various manners. By way of example, two media content items can be regarded as similar in one aspect (e.g., artist) or different in another aspect (e.g., genre). According to different standards of similarity, the vectors can be weighted in different manners suitable for such different similarity standards.

At operation 440, the vector-based recommendation engine 354 determines media content items based on the similar vectors. Once one or more similar vectors are identified at the operation 438, at least some of the media content items associated with the similar vectors can be identified and determined as recommended media content items for the current playlist.

At operation 442, the vector-based recommendation engine 354 can update the current playlist with at least one of the recommended media content items. In some embodiments, the vector-based recommendation engine 354 provides a user interface, such as the user interface 132 of the media-playback device 102 that enables a user to manually add at least one of the recommended media content items to the current playlist. For example, a predetermined number of recommended media content items are presented to the user through the user interface and the user can select one or more of the recommended media content items in the playlist. In other embodiments, the vector-based recommendation engine 354 can automatically update the current playlist with at least one of the recommended media content items.

FIG. 12 illustrates another example method 450 for operating the vector-based recommendation engine 354. The method 450 is primarily described to be performed by the media delivery system 104. In other embodiments, however, the method 450 can be performed by the media playback device 102 or one or more other computing devices.

At operation 452, the vector-based recommendation engine 354 receives the suggestion characteristic data 232 of the playlist character suggestions 230 that have been selected by the user. In some embodiments, the vector-based recommendation engine 354 can utilize data of a user identifier or a playlist identifier to generate recommendation of media content items. In other embodiments, the vector-based recommendation engine 354 can use other types of the suggestion characteristic data 232, such as factual data relating to media content items (e.g., media content item titles, album titles, artist names, composer names, other credits, album cover art, publisher name and product number, etc.), acoustic data (e.g., tempo, rhythm, beats, downbeats, tatums, patterns, sections, melody, pitch, harmony, timbre, chroma, loudness, vocalness, etc.), and cultural attributes (e.g., styles, genres, moods, themes, similar artists and/or songs, rankings, etc.).

At operation 454, the vector-based recommendation engine 354 obtains a playlist associated with the suggestion characteristic data 232. For example, where the suggestion characteristic data 232 includes a user identifier, one of the playlists that are associated with the user identifier (i.e., one of the playlists owned or shared by or with a user identified by the user identifier) is obtained. Various criteria can be used to select one of the playlists associated with the user identifier. By way of example, the most popular playlist can be selected from the playlists associated with the user identifier. In other embodiments, a plurality of playlists can be obtained from the playlists associated with the user identifier.

In other examples, where the suggestion characteristic data 232 includes another type of data element, such as a media content item, artist, album, etc., one of the playlists that are associated with such a data element is obtained. By way of example, where an artist is concerned, one of the playlists that are associated with, or include, the artist is selected. Various criteria can be used to select one of the playlists associated with such a data element. By way of example, the most popular playlist can be selected from the playlists associated with such a data element. In other embodiments, a plurality of playlists can be obtained from the playlists associated with such a data element.

In yet other examples, where the suggestion characteristic data 232 includes a playlist identifier, the playlist identified by the playlist identifier can be simply obtained.

At operation 456, the playlist obtained at the operation 454 is identified as a seed playlist, which is inputted into the playlist-based recommendation engine 352. The playlist-based recommendation engine 352 can then perform the operations as illustrated in FIG. 10 using the seed playlist.

FIGS. 13A-13E illustrate an example user interface 500 presented on a user computing device, such as the media playback device 102. The user interface 500 can be an example of the user interface 300 as illustrated in FIG. 6. Referring primarily to FIG. 13A, the user interface 500 shows a list of existing playlists 502 and includes a control element 504 for allowing a user to create a playlist 508. Once the control element 504 is selected, the user interface 500 can provide a text field 506 that enables a user to enter a title for the new playlist. In FIG. 13A, “Mood” is entered as the title of a new playlist.

Referring to FIG. 13B, the user interface 500 includes a playlist information section 510 which shows information about the playlist that is currently open, such as the title of the current playlist and the user who creates or shares the current playlist. The user interface 500 further includes a playlist making assistance section 512 that assists the user to define the theme of the playlist 508. As described herein, the playlist making assistance engine 110 operates to assist the user to characterize the playlist 508 and provide recommendations of media content items for the playlist 508.

The playlist making assistance section 512 includes a control element 516 for receiving a user request for activating the playlist making assistance engine 110. For example, when the control element 516 is selected, the playlist making assistance engine 110 performs the method 200 as described herein.

In some embodiments, the user interface 500 further includes a media recommendation section 514 that shows a list of media content items that are recommended based on the current playlist 508. For example, when the playlist 508 is created or opened, the playlist-based recommendation engine 352 can generate a list of recommended media content items using the current playlist 508 as a seed playlist. An example method of operating the playlist-based recommendation engine 352 has been described herein and disclosed in U.S. Patent Application Ser. No. 62/441,035, titled MEDIA CONTENT ITEM RECOMMENDATION SYSTEM, filed Dec. 30, 2016, the disclosure of which is incorporated herein by reference in its entirety.

As illustrated in FIG. 13B, the playlist making assistance section 512 states that there is no media content item associated with the playlist (“This playlist is currently empty” in FIG. 13B). The user may either select media content items from the list in the media recommendation section 514 or use the playlist making assistance by the playlist making assistance engine 110. The playlist making assistance section 512 includes a statement that the user can select media content items from the list of recommended media content items shown in the media recommendation section 514, or activate the playlist making assistance to find media content items suitable for the playlist. (“Check out Recommended Songs Below, or let us help you make the perfect playlist.” In FIG. 13B).

Referring to FIG. 13C, when the control element 516 (FIG. 13B) is selected and the playlist making assistance is activated, the playlist making assistance section 512 shows a suggestion section 520 and a user selection display section 522. The user selection display section 522 can be an example of the user selection display section 308 as illustrated in FIG. 6. The suggestion section 520 shows a plurality of tiles 524 that correspond with the playlist character suggestions 230 generated by the playlist making assistance engine 110. The tiles 524 can be examples of the tiles 304 as illustrated in FIG. 6. The tiles 524 include descriptions 526 of the suggestion characteristic data 232 of the playlist character suggestions 230 (e.g., “Common,” “Lil Uzi-Vert,” “Young Thug,” “Mac Miller,” “The Pretty Reckless,” “Wiz Khalifa,” “The Chain Gang Of 1974,” and “The Weekend”). The descriptions 526 can be example of the descriptions 306 as illustrated in FIG. 6.

In this example, the tiles 524 are arranged in a grid and include pictures or graphics that can represent the descriptions 526. Other arrangements and configurations are also possible for the tiles 524.

Referring to FIG. 13D, as one or more tiles 524 are selected, the user selection display section 522 shows the descriptions 526 of the selected tiles 524 to indicate the playlist character suggestions 230 that are selected. Once the selection is done, the user can finish selecting tiles through a control element 528.

As described herein, as one or more playlist character suggestions 230 are selected from a set of playlist character suggestions 230, the set of playlist character suggestions 230 can be updated with other playlist character suggestions 230 and the suggestion section 520 is updated with new tiles 524B (e.g., “July Talk,” “Metallica,” “Anne-Marie,” “2 Chainz,” and “Kalea” in FIG. 13D) corresponding to such other playlist character suggestions 230. As described herein, in some embodiments, the other playlist character suggestions 230 are newly added to replace the playlist character suggestions 230 that have been selected. In addition, as the user selects one or more from the set of playlist character suggestions 230 (displayed in the form of tiles 524), one or more of the playlist character suggestions 230 that have not been selected can also be removed from the set and replaced by the other playlist character suggestions 230. For example, if such non-selected playlist character suggestions are determined to be irrelevant or less relevant to the user's previous selection of playlist character suggestions 230 for the playlist, the irrelevant or less relevant playlist character suggestions can be replaced by new playlist character suggestions.

Referring to FIG. 13E, when the user selection of tiles 524 are completed, the user interface 500 shows a list of recommended media content items 530 based on the user selection. The list of recommended media content items 530 is generated by the playlist making assistance engine 110 as described herein. In some embodiments, the user can manually add at least one of the recommended media content items to the playlist 508. In other embodiments, the recommended media content items are automatically added to the playlist 508.

Once the recommended media content items are added to or associated with the playlist, the user can play the recommended media content items using a playback tool 532 in the user interface 500.

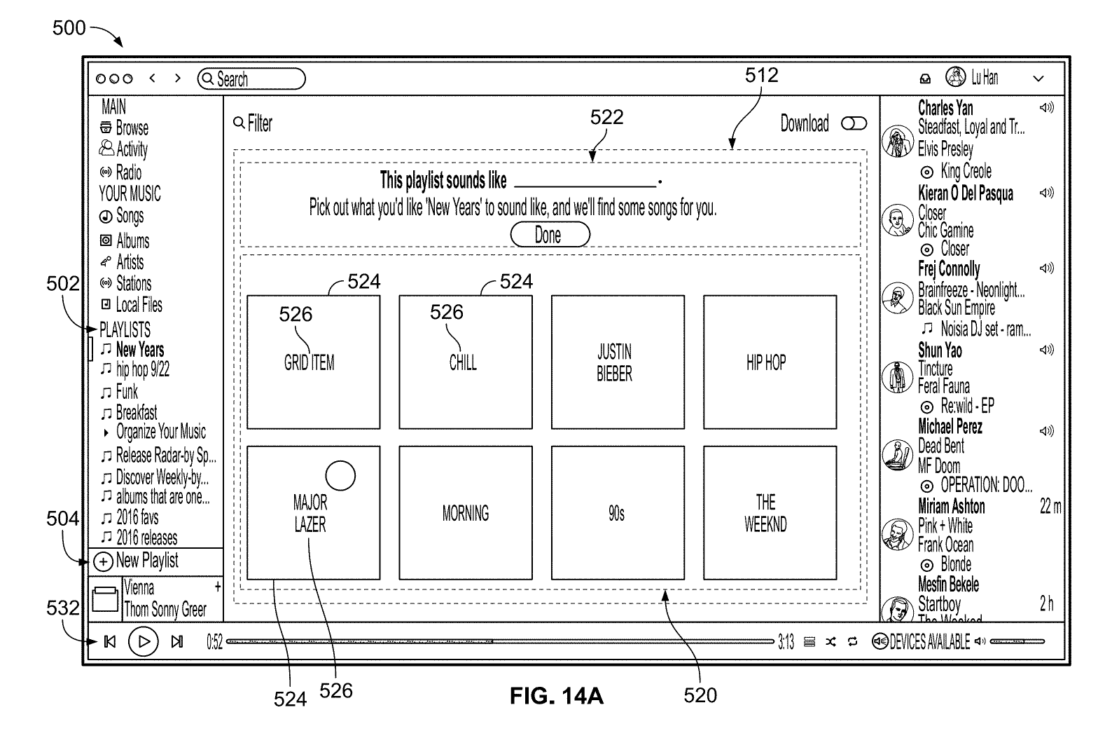

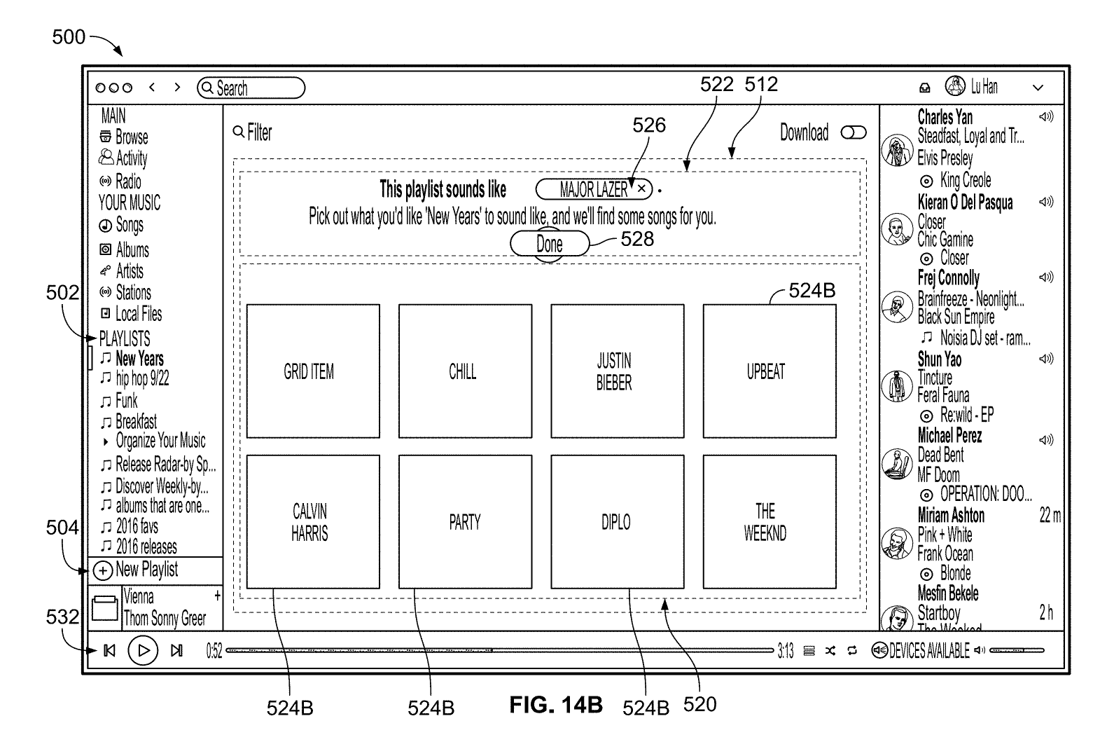

FIGS. 14A and 14B illustrate another embodiment of the tiles 524. In this example, the tiles 524 are configured as monochromatic solid blocks with descriptions 526 of the corresponding playlist character suggestions 230. Other configurations of the tiles 524 are also possible in other embodiments.

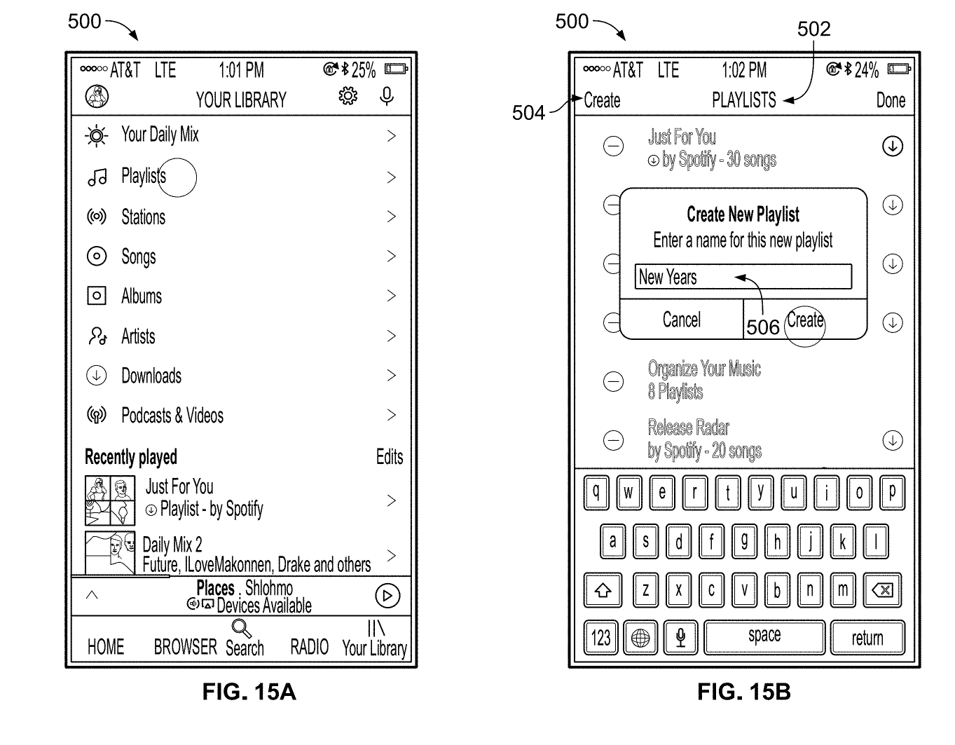

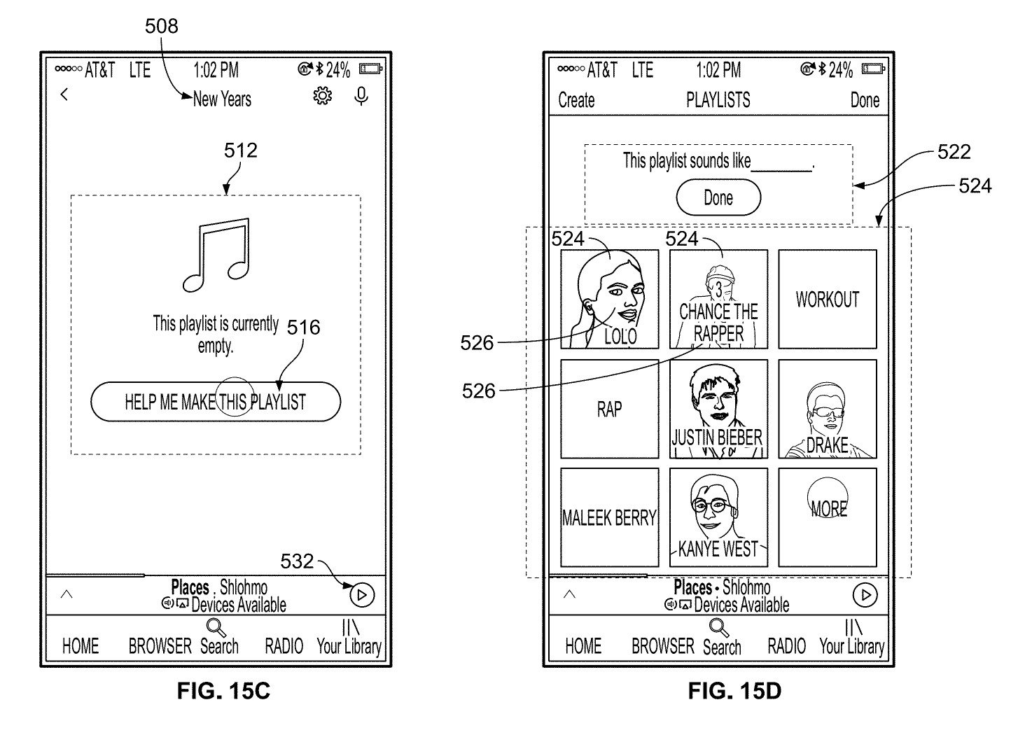

FIGS. 15A-15D illustrate another example user interface 500 presented on a computing device, such as the media playback device 102. In some embodiments, the user interface 500 in this example is used for a display resolution suited for a mobile computing device. Although an example arrangement of the user interface 500 as shown in FIGS. 15A-15D is different from the arrangement of the user interface 500 shown in FIGS. 13A-13D, the principle of the user interface 500 in this example is identical or similar to that of the user interface 500 of FIGS. 13A-13E. Therefore, the same reference numbers are used where like or similar features or elements are shown, and the description of the user interface 500 in this example is omitted for brevity purposes.

The various examples and teachings described above are provided by way of illustration only and should not be construed to limit the scope of the present disclosure. Those skilled in the art will readily recognize various modifications and changes that may be made without following the examples and applications illustrated and described herein, and without departing from the true spirit and scope of the present disclosure.

1. A method for adding media content items to a new playlist, the method comprising:
receiving a user request to create the new playlist;
identifying a selected set of playlist character suggestions including a first character suggestion and a second character suggestion, by:
generating a first set of playlist character suggestions each usable to characterize the new playlist;
receiving a user selection of the first character suggestion from the first set of playlist character suggestions;
updating the playlist character suggestions based on the user selection of the first character suggestion to generate a second set of playlist character suggestions, wherein the second set of playlist character suggestions is different than the first set of playlist character suggestions; and
receiving a user selection of the second character suggestion from the second set of playlist character suggestions;
determining media content items based on the selected set of playlist character suggestions including at least the first and second character suggestions, wherein the playlist character suggestions are different than titles of the media content items; and
associating at least some of the determined media content items with the new playlist.

2. The method of claim 1, further comprising:
transmitting data to a media playback device, the data usable to play the media content items via the media playback device.

3. The method of claim 1, further comprising:
updating the playlist character suggestions with new playlist character suggestions based on the user selection.

4. The method of claim 1, further comprising:
displaying a plurality of control elements associated with the playlist character suggestions.

5. The method of claim 4, wherein each of the plurality of control elements is configured as a tile.

6. The method of claim 4, wherein each of the plurality of control elements includes a description of a playlist character suggestion.

7. The method of claim 1, wherein the description of a playlist character suggestion includes at least one of a media content item name, an artist name, an album name, a playlist identifier, a user identifier, and a string descriptive of a theme, genre, mood, or era.

8. The method of claim 1, wherein the playlist character suggestions are generated based on at least one of a general popularity, a user history, and a user selection of playlist character suggestion.

9. The method of claim 1, wherein the media content items are determined using a playlist-based recommendation engine.

10. The method of claim 1, wherein the media content items are determined using a vector-based recommendation engine.

11. A method of playing media content items, the method comprising:
receiving a user request to create a playlist;
prompting a user to activate a playlist making assistance engine;
identifying a selected set of playlist character suggestions including a first character suggestion and a second character suggestion, by:
presenting a first set of playlist character suggestions in the user interface, the plurality of playlist character suggestions each usable to characterize the playlist;
receiving a user selection of the first character suggestion from the first set of playlist character suggestions;
updating the plurality of playlist character suggestions based on the user selection of the first character suggestion; and
receiving a user selection of a second character suggestion of the updated plurality of playlist character suggestions to generate a second set of playlist character suggestions, wherein the second set of playlist character suggestions is different than the first set of playlist character suggestions;
presenting at least one recommended media content item in the user interface, the at least one recommended media content item being determined based on the selected set of playlist character suggestions including at least the first and second character suggestions, wherein the playlist character suggestions are different than titles of the media content items; and
enabling a user to include the at least one recommended media content item in the playlist.

12. The method of claim 11, further comprising:
updating the playlist character suggestions by replacing the at least of the playlist character suggestions with new playlist character suggestions.

13. The method of claim 11, wherein presenting the first set of playlist character suggestions includes:
displaying a plurality of control elements associated with the first set of playlist character suggestions.

14. The method of claim 13, wherein each of the plurality of control elements is configured as a tile.

15. The method of claim 13, wherein each of the plurality of control elements includes a description of a playlist character suggestion.

16. The method of claim 15, wherein the description of a playlist character suggestion includes at least one of a media content item name, an artist name, an album name, a playlist identifier, a user identifier, and a string descriptive of a theme, genre, mood, or era.

17. The method of claim 11, wherein the first set of playlist character suggestions are generated based on at least one of a general popularity, a user history, and a user selection of a playlist character suggestion.

18. The method of claim 11, wherein the at least one recommended media content item is determined using a playlist-based recommendation engine.

19. The method of claim 11, wherein the at least one recommended media content item is determined using a vector-based recommendation engine.

20. A system for delivering media content items using a playlist, the system comprising:
a processing device;
a media data store storing a plurality of media content items; and
a computer readable data storage medium storing software instructions that, when executed by the processing device, cause the system to:
receive a request for creating a playlist;
receive a request for playlist making assistance for the playlist;
identify a selected set of playlist character suggestions including a first character suggestion and a second character suggestion, by:
upon receiving the request for playlist making assistance, generate a first set of playlist character suggestions each usable to characterize the playlist;
receive a user selection of the first character suggestion from the first set of playlist character suggestions;
update the playlist character suggestions based on the user selection of the first character suggestion to generate a second set of playlist character suggestions, wherein the second set of playlist character suggestions is different than the first set of playlist character suggestions; and
receiving a user selection of the second character suggestion from the second set of playlist character suggestions;
determine media content items based on the selected set of playlist character suggestions including at least the first and second character suggestions, wherein the playlist character suggestions are different than titles of the media content items;
associate at least some of the determined media content items with the playlist; and
enable a user to play back the determined media content items.

21. The method of claim 1, wherein the new playlist is a playlist having no media content item associated therewith prior to associating the determined media content items with the new playlist.

22. The method of claim 1, wherein identifying the selected set of playlist character suggestions occurs before selecting media content items to be included in the new playlist.

23. The method of claim 11, wherein identifying the selected set of playlist character suggestions occurs before selecting media content items to be included in the new playlist.
